(19) United States
(12) Patent Application Publication
(10) Pub. No.: US 2014/0120949 A1
(43) Pub. Date: May 1, 2014

(54) COMMUNICATION DEVICE, COMMUNICATION SYSTEM, SERVER DEVICE AND COMMUNICATION METHOD

(71) Applicant: PANASONIC CORPORATION, Osaka (JP)

(72) Inventor: Kazumasa Gomyo, Kanagawa (JP)

(73) Assignee: PANASONIC CORPORATION, Osaka (JP)

(21) Appl. No.: 14/126,936

(22) PCT Filed: Jun. 27, 2012
(86) PCT No.: PCT/JP2012/004182

§ 371 Date: Dec. 17, 2013

(30) Foreign Application Priority Data
Jun. 30, 2011 (JP) 2011-146165

(51) Int. Cl. H04W 4/04; H04M 1/02

(52) U.S. Cl. CPC H04W 4/04; H04M 1/0266
USPC 455/456.1

(57) ABSTRACT

A communication device includes a manipulation unit for receiving an input manipulation for operation mode switching; a position detection unit for detecting a current position; a communication unit for acquiring pieces of position information of other communication device from the other communication device, respectively; a generation unit for generating pieces of proximity information indicating whether the other respective communication device are dose to the communication device; a data storing unit for storing the pieces of proximity information; and a control unit which, when receiving an input manipulation for operation mode switching, urges a user to switch the operation modes of other communication device that are close to the communication device according to a new operation mode of the communication device.

### TECHNICAL FIELD

The present invention relates to a communication device, a communication system, a server device, and a communication method which allow other communication device to be notified of operation mode switching made in a communication device.

### BACKGROUND ART

In areas (hospitals, airplanes, etc.) where radio waves used for communications may adversely affect surroundings, it is necessary to set the operation mode to a power-off mode or a radio-wave-off mode to disable portable terminals to emit radio waves. The power-off mode is an operation mode in which a portable terminal is powered off. The radio-wave-off mode is an operation mode in which one portable terminal is prevented from emitting radio waves.

In particular, when a user has plural portable terminals in such an area, he or she is required to set all portable terminals that emit radio waves in the power-off mode or the radio-wave-off mode. However, user may forget to make operation mode set setting. In view of occurrence of such events, a technique for causing plural portable terminals to cooperate automatically to prohibit use of radio waves has been developed (refer to Patent document 1).

### PRIOR ART DOCUMENTS

### Patent Documents

Patent document 1: JP-A-2009-164783

### SUMMARY OF THE INVENTION

### Problems to be Solved by the Invention

A portable terminal which is an example communication device may have plural wireless communication means other than one for wireless communication with a base station. However, even if each of plural portable terminals owned by a user has wireless communication means other than one for communication with a base station, the technique disclosed in Patent document 1 is not applicable if they include even one portable terminal whose such wireless communication means cannot be used.

An object of the present invention is to provide a communication device, a communication system, a server device, and a communication method which make it possible to inform a user of presence of another or other communication device whose operation modes need to be switched according to operation mode switching made in a self communication device in the case where one or plural other communication device that are correlated with the communication device exist in its vicinity.

### Means for Solving the Problems

The invention provides a communication device comprising a display unit; a manipulation unit that receives an input manipulation for switching an operation mode of the communication device; a position detection unit that detects a position of the communication device; a communication unit that acquires position information of other communication device correlated with the communication device from the other communication device through an external network, a generation unit that generates proximity information indicating whether the other communication device is located close to the communication device, on the basis of a detection result of the position detection unit and the position information of the other communication device; a data storing unit that stores the proximity information; and a control unit that, when the manipulation unit receives an input manipulation for switching the operation mode of the communication device, controls the display unit to make a display for urging a user to switch operation modes of other communication device that are close to the communication device according to a new operation mode of the communication device.

In the above communication device, when the manipulation unit receives a prescribed manipulation after the display unit has made the display, the control unit communicates, to the other communication device, an instruction to switch to the same operation mode as the new operation mode of the communication device.

In the above communication device, when receiving the instruction, the other communication device switches its operation mode to the same operation mode as the new operation mode of the communication device.

In the above communication device, the generation unit generates, in addition to the proximity information, connection information indicating whether the other communication device is connected to the communication device through the external network; the data storing unit stores the connection information in addition to the proximity information; and when the manipulation unit receives an input manipulation for switching the operation mode of the communication device, the control unit controls the display unit to make a display for urging a user to switch operation modes of other communication device that is close to and is connected to the communication device according to a new operation mode of the communication device.

A communication system according to the invention is a communication system including a server device and plural communication devices that are connected to the server device through an external network, wherein the server device comprises an acquisition unit that acquires position information from the plural communication devices correlated with each other through the external network; a generation unit that generates proximity information indicating whether the plural communication device are located close to each other on the basis of the acquired position information of the plural communication devices; and a communication unit that, when proximity information is updated, sends updated proximity information to plural communication devices indicated by the updated proximity information; and each of the plural communication devices comprises a display unit; a manipulation unit that receives an input manipulation for switching an operation mode of the communication device; a position detection unit that detects a position of the communication device; a communication unit that acquires the proximity information from the server device through the network; and a control unit that controls, when the manipulation unit receives an input manipulation for switching the operation mode of the communication device, the display unit to make a display for urging a user to switch operation modes of other communication device that is close to the communication device according to a new operation mode of the communication device.

A communication method according to the invention comprises the steps of receiving, by a manipulation unit, an input manipulation for switching an operation mode of a communication device; detecting, by a detection unit, a position of the communication device; acquiring, by an acquisition unit, position information of other communication device correlated with the communication device from the other communication device through an external network; generating, by a generation unit, proximity information indicating whether the other communication device is located close to the communication device, on the basis of the detected position of the communication device and the position information of the other respective communication device; storing the proximity information by a data storing unit; and when receiving an input manipulation for switching the operation mode of the communication device, controlling, by a control unit, a display unit so that it makes a display for urging a user to switch operation modes of other communication device that are close to the communication device according to a new operation mode of the communication device.

Another communication system according to the invention is a communication system including a server device and plural communication devices that are connected to the server device through an external network, wherein the server device comprises an acquisition unit that acquires position information from the plural communication devices registered in advance over the external network; a generation unit that generates proximity information indicating whether the plural communication devices are located close to each other on the basis of the acquired position information of the plural communication devices; a data management unit that manages the proximity information generated by the generation unit and operation mode switching settings that are set for the plural communication devices; and a communication unit that receives an operation mode switching notice from one of the plural communication device through the external network, and sends, through the external network, operation mode switching instruction to the communication device that is close to the communication device from which the operation mode switching notice has been received; and each of the plural communication devices comprises a display unit; a manipulation unit that receives an input manipulation for switching an operation mode of the communication device; a position detection unit that detects a position of the communication device; a communication unit that sends an operation mode switching notice to the server device trhough the network when the operation mode of the communication device has been switched, and receives the operation mode switching instruction from the server device through the network; and a control unit that, when the communication unit receives the operation mode switching instruction, switches the operation mode or controls the display unit to display a picture for urging a user to switch the operation mode according to the operation mode switching setting of the communication device in response to the operation mode switching instruction.

A further communication system is a communication system including a server device and plural communication devices that are connected to the server device through an external network, wherein the server device comprises an acquisition unit that acquires position information from the plural communication devices registered in advance through the external network; a memory unit that stores position information acquired by the acquisition unit in time series for the plural communication devices; a generation unit that, when an operation mode switching notice is received from one of the plural communication device through the external network, generates proximity information indicating whether the communication device from which the operation mode switching notice has been received and other communication device are located close to each other, on the basis of the position information stored by the memory unit; a data management unit that manages the proximity information generated by the generation unit and operation mode switching settings that are set for the plural communication devices; and a communication unit that receives an operation mode switching notice from one of the plural communication devices through the external network, and sends, through the external network, an operation mode switching instruction to a communication device that is close to the communication device from which the operation mode switching notice has been received; and each of the plural communication devices comprises a display unit; a manipulation unit that receives an input manipulation for switching an operation mode of the communication device; a position detection unit that detects a position of the communication device; a communication unit that sends an operation mode switching notice to the server device through the network when the operation mode of the communication device has been switched, and receiving the operation mode switching instruction from the server device through the external network; and a control unit that, when the communication unit receives the operation mode switching instruction, switches the operation mode or controls the display unit to display a picture for urging a user to switch the operation mode according to the operation mode switching setting of the communication device in response to the operation mode switching instruction.

In each of the above communication systems, after sending the operation mode switching instruction to the close communication device, the server device disregards an operation mode switching setting sent from the close communication device until a lapse of a prescribed time.

A server device according to the invention is a server device which is connected to plural communication devices through an external network, comprising an acquisition unit that acquires position information from the plural communication devices registered in advance over the external network; a generation unit that generates proximity information indicating whether the plural communication devices are located close to each other on the basis of the acquired position information of the plural communication device; a data management unit that manages the proximity information generated by the generation unit and operation mode switching settings that are set for the plural communication devices; and a communication unit that receives an operation mode switching notice from one of the plural communication devices through the external network, and sends, through the external network, operation mode switching instructions to the communication device that is close to the communication device from which the operation mode switching notice has been received.

Another server device according to the invention is a server device which is connected to plural communication devices through an external network, comprising an acquisition unit that acquires position information from the plural communication devices registered in advance through the external network; a memory unit that stores position information acquired by the acquisition unit in time series for the plural communication devices; a generation unit that, when an operation mode switching notice is received from one of the plural communication device through the external network, generates proximity information indicating whether the communication device from which the operation mode switching notice has been received and other communication device are located close to each other, on the basis of the position information stored by the memory unit; a data management unit that manages the proximity information generated by the generation unit and operation mode switching settings that are set for the plural communication devices; and a communication unit that receives an operation mode switching notice from one of the plural communication devices through the external network, and sends, through the external network, an operation mode switching instruction to the communication device that is close to the communication device from which the operation mode switching notice has been received.

In the above server device, when the communication unit has sent the operation mode switching instruction to the dose communication device, the server device disregards an operation mode switching setting sent from the close communication device until a lapse of a prescribed time.

### Advantageous Effects of the Invention

The communication device, communication system, server device, and communication method according to the invention make it possible to inform a user of presence of another or other communication device whose operation modes need to be switched according to operation mode switching made in a self communication device in the case where one or plural other communication device that are correlated with the communication device exist in its vicinity.

### BRIEF DESCRIPTION OF THE DRAWINGS

FIG. 1 is a schematic diagram showing the configuration of a communication system according to a first embodiment of the present invention.

FIG. 2 is a block diagram showing the configuration of a terminal 1.

FIG. 3 shows example (1) of data that are managed by a data management unit 130.

FIG. 4 is a sequence diagram example (1) for update of pieces of proximity information.

FIG. 5 is a flowchart example (1) that is executed when an operation mode switching manipulation is made.

FIG. 6 shows a display example (1) of a display unit 170.

FIG. 7 is a flowchart example (2) that is executed when an operation mode switching manipulation is made.

FIG. 8 shows a display example (2) of the display unit 170.

FIG. 9 is a sequence diagram example (2) for update of pieces of proximity information.

FIG. 10 is a sequence diagram example (3) for update of pieces of proximity information.

FIG. 11 shows example (2) of management data of the data management unit 130.

FIG. 12 shows example (3) of management data of data management unit 130.

FIG. 13 is a flowchart example (3) that is executed when an operation mode switching manipulation is made.

FIG. 14 is a schematic diagram showing the configuration of a communication system according to a second embodiment of the invention.

FIG. 15 shows an example of data that are managed by a server device 5.

FIG. 16 is a sequence diagram example (4) for update of pieces of proximity information.

FIG. 17 is a block diagram showing the configuration of the server device 5.

FIG. 18 is a block diagram showing the configuration of a terminal 6.

FIG. 19 is a schematic diagram showing the configuration of a communication system according to a third embodiment of the invention.

FIG. 20 shows an example of data relating to pieces of information indicating pairs of terminals and pieces of proximity information that are managed by a server device 15.

FIG. 21 shows an example of data relating to operation mode switching settings of respective terminals that are managed by the server device 15.

FIG. 22 is a sequence diagram example (4) showing a process that is executed by the communication system according to the third embodiment.

FIG. 23 shows an example picture that is displayed at step S2214 when a terminal whose operation mode switching setting is “manual” receives an operation mode switching instruction.

FIG. 24 shows an example picture that is displayed at step S2216 when a terminal whose operation mode switching setting is “automatic” receives an operation mode switching instruction.

FIG. 25 is a block diagram showing the configuration of the server device 15.

FIG. 26 is a block diagram showing the configuration of a terminal 16.

FIG. 27 is a schematic diagram showing the configuration of a communication system according to a fourth embodiment of the invention.

FIG. 28 shows an example of data relating to position information that are managed by a server device 25.

FIG. 29 shows an example of data relating to the operation mode switching settings of respective terminals that are managed by the server device 25.

FIG. 30 is a sequence diagram example showing a process that is executed by the communication system according to the fourth embodiment.

FIG. 31 shows an example of pieces of proximate information generated by the server device 25.

FIG. 32 is a block diagram showing the configuration of the server device 25.

### MODE FOR CARRYING OUT THE INVENTION

Embodiments of the present invention will be hereinafter described with reference to the drawings.

### Embodiment 1

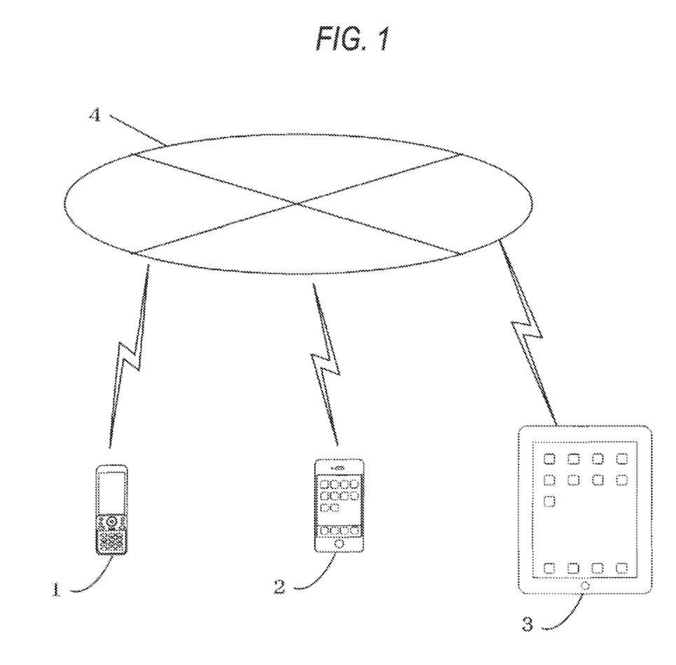

FIG. 1 is a schematic diagram showing the configuration of a communication system according to a first embodiment of the invention. As shown in FIG. 1, portable terminals 1, 2, and 3 which are example communication device according to the invention make a connection to an external network 4 independently of each other. The portable terminals 1, 2, and 3 perform a data a communication with each other over the external network 4. In the following description, the portable terminals 1, 2, and 3 will be referred to simply as terminals 1, 2, and 3.

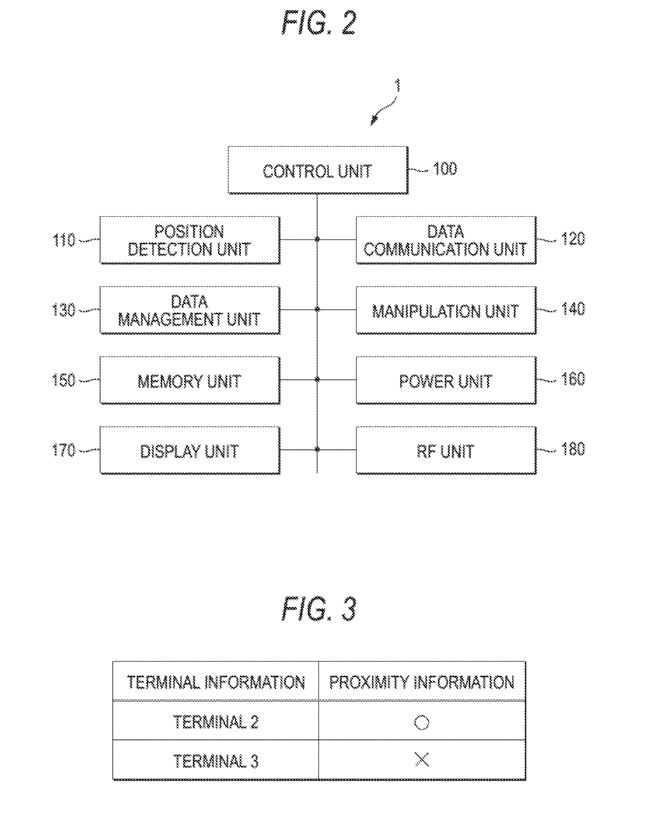

FIG. 2 is a block diagram showing the configuration of the terminal 1. Although the terminal 1 will be described as an example terminal with reference to FIG. 2, the other terminals 2 and 3 (see FIG. 1) have similar configurations. As shown in FIG. 2, the terminal 1 is equipped with a control unit 100, a position detection unit 110, a data communication unit 120, a data management unit 130, a manipulation unit 140, a memory unit 150, a power unit 160, a display unit 170, and an RF unit 180.

Components having common functions of a portable terminal, such as an antenna, a microphone, and a battery, are omitted in FIG. 2.

Although in FIG. 2 the data management unit 130 of the terminal 1 is shown as a functional block, data may be managed by applications. What manages data is thus not limited to the data management unit 130.

The control unit 100 is composed of a central processing unit (CPU), a timer, a memory, etc. The control unit 100 controls the entire terminal 1, that is, controls the position detection unit 110, the data communication unit 120, the data management unit 130, the manipulation unit 140, the memory unit 150, the power unit 160, the display unit 170, the RF unit 180, etc.

The control unit 100 refers to current position information, stored by the memory unit 150, of each of the terminals 2 and 3 belonging to the same group and updates proximity information of each terminal stored by the data management unit 130. More specifically, the control unit 100 judges whether or not each of the other terminals 2 and 3 for which group setting is made is close to the self terminal (terminal 1) on the basis of a difference between current position information of each of the terminals 2 and 3 and that of the self terminal, and updates the proximity information, managed by the data management unit 130, of each of the other terminals 2 and 3.

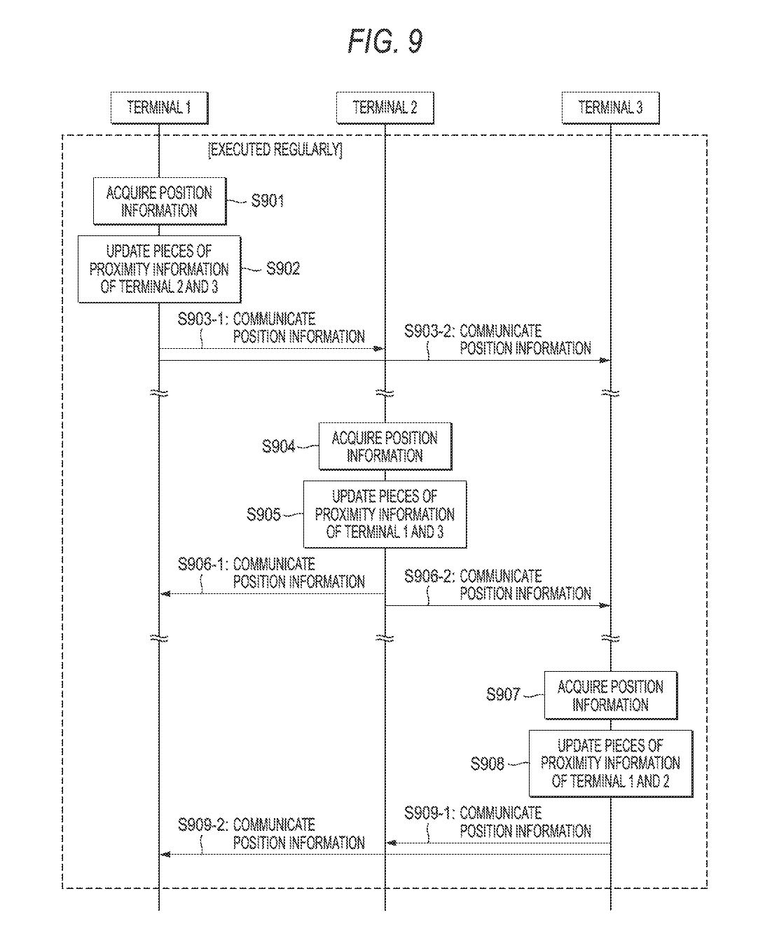

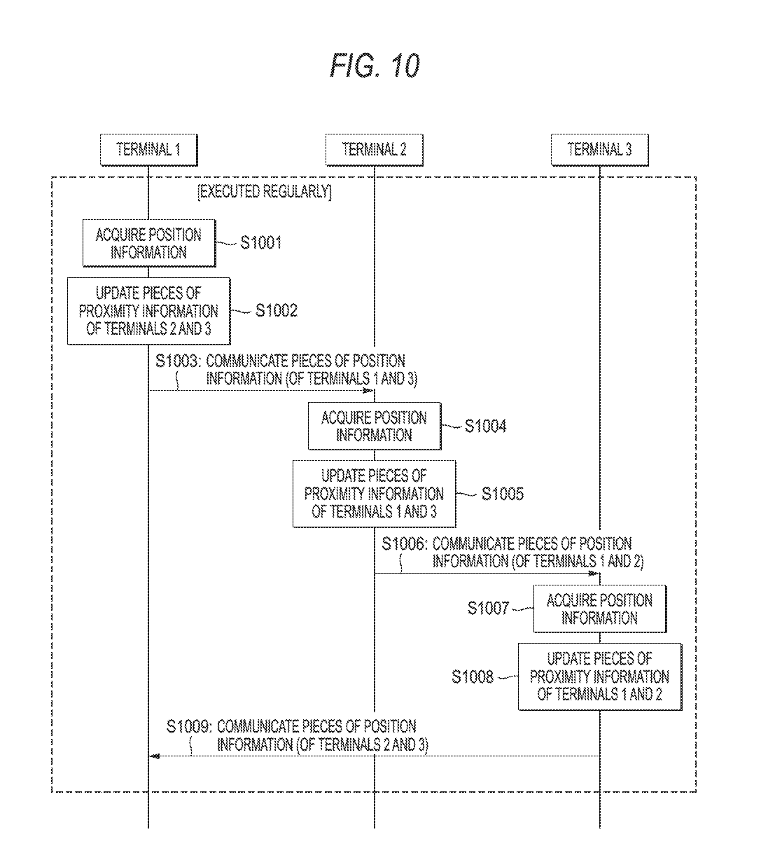

If past position information of each of the terminals 2 and 3 belonging to the same group is stored, the control unit 100 may update the proximity information of each of the terminals 2 and 3 using not only current position information of each of the terminals 2 and 3 stored by the memory 150 but also a difference between the current position information and the past position information. This is a particularly effective update method in the case where the position information of each of the terminals 2 and 3 is not updated frequently (e.g., see examples of FIGS. 9 and 10).

The control unit 100 switches the operation mode of the self terminal (terminal 1) in response to an input manipulation performed on the manipulation unit 140 or an operation mode switching instruction that is communicated from another terminal belonging to the same group. In this embodiment, three operation modes, that is, a radio-wave-off mode in which radio waves are not emitted to the outside, a power-off mode in which the power is kept off, and a normal mode in which an ordinary operation is performed by emitting radio waves to the outside, are assumed. However, the operation modes are not limited to them.

In switching from the normal mode or the radio-wave-off mode to the power-off mode, the control unit 100 performs a control for shutting off the power supplied from the power unit 160. In switching from the normal mode or the power-off mode to the radio-wave-off mode, the control unit 100 controls the RF unit 180 so as to prohibit emission of radio waves to the outside with power supplied from the power unit 160.

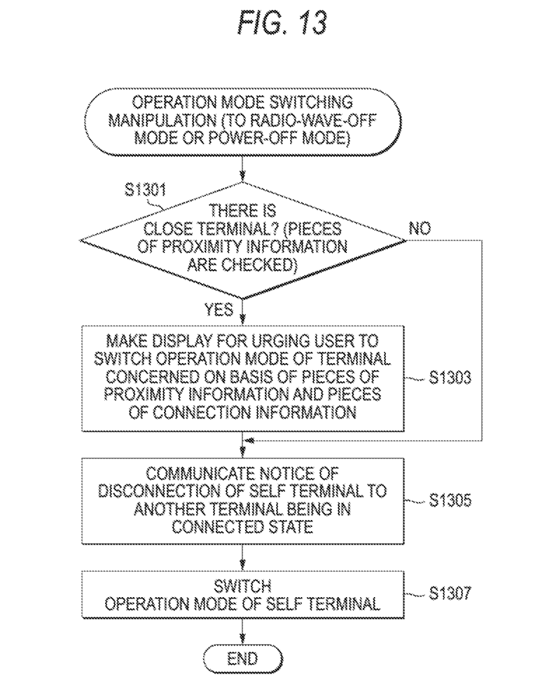

In switching the operation mode in the above manner, the control unit 100 refers to the proximity information of each of the terminals 2 and 3 that is managed by the data management unit 130. If at least one of the terminals 2 and 3 for which the group setting is made is close to the self terminal (terminal 1), the control unit 100 causes the display unit 170 to make a display that urges the user to switch the operation mode of the close terminal(s) according to the operation mode of the self terminal (terminal 1). If neither of the terminals 2 and 3 for which the group setting is made is close to the self terminal (terminal 1), the control unit 100 does not cause the display unit 170 to make any display.

Where not only the terminal information and the proximity information of each of the other terminals 2 and 3 but also connection information of each of the terminals 2 and 3 is managed by the data management unit 130, the control unit 100 sends position information of the self terminal (terminal 1) to one or both, dose to and connected to the self terminal (terminal 1), of the terminals 2 and 3 via the data communication unit 120 (see FIGS. 12 and 13). When a transition is to be made to a state that the self terminal (terminal 1) will not be connected to the other terminal 2 and/or terminal 3 via the external network 4, the control unit 100 sends a disconnection notice to the terminal 2 and/or terminal 3 for which the group setting is made via the data communication unit 120. When a connected state is to be restored from such a disconnected state, the control unit 100 re-establishes a connection to the terminal 2 and/or terminal 3 for which the group setting is made via the data communication unit 120. As a result, sending of position information to the terminal(s) that was once disconnected is restarted.

The control unit 100 controls the display unit 170 so that it displays a message for inquiring of a user whether to change the settings of another, close terminal. If the operation mode setting of another, close terminal is to be changed, the control unit 100 sends, to the other terminal, an instruction to change the operation mode setting via the data communication unit 120.

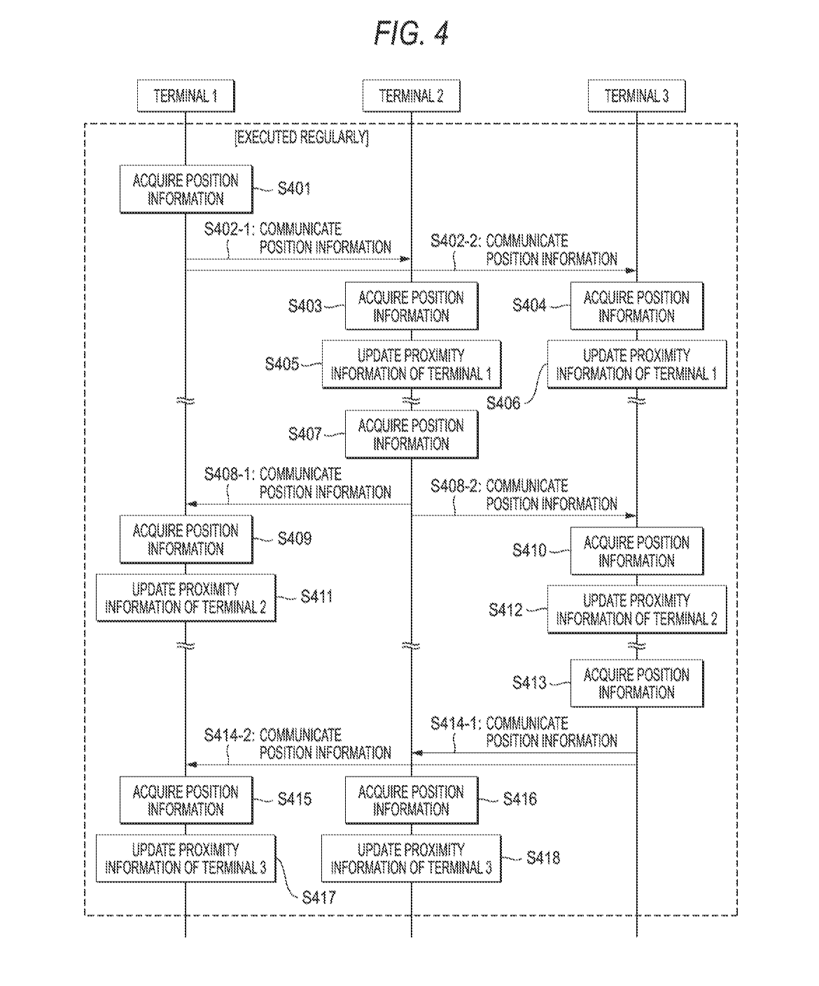

The data management unit 130 sends current position information of the self terminal (terminal 1) that is output from the position detection unit 110 to the terminals 2 and 3 over the external network 4 on a regular basis (see FIG. 4). Furthermore, the data communication unit 120 receives current position information from each of the terminals 2 and 3 belonging to the same group and outputs the received current position information to the position detection unit 110. Pieces of position information of the terminals may be either exchanged on a regular basis using the timer incorporated in the control unit 100 or exchanged irregularly.

The manipulation unit 140 receives a user input manipulation and outputs a signal corresponding to the input manipulation to the control unit 100. The manipulation unit 140 is an input interface such as input keys (e.g., power button) or a touch panel.

The display unit 170 displays output information corresponding to a user input manipulation under the control of the control unit 100. The display unit 170 is an output interface such as a touch panel screen or a liquid crystal screen. The display unit 170 may be a touch panel that also serves as the manipulation unit 140.

### <Management of Proximity Information>

The data management unit 130 stores a list of plural terminals that are set in advance as belonging to a group (hereinafter referred to as pieces of terminal information) and pieces of proximity information for judgment as to whether or not these terminals are located close to the self terminal (terminal 1). Although in this embodiment one or plural terminals are set in advance as belonging to a group, group setting can also be made through manual registration, registration by a short-distance wireless communication or a mail, registration using a personal computer, a storage device, or the like, or by a like method.

### [Example (1) of Management Data of Data Management Unit 130]

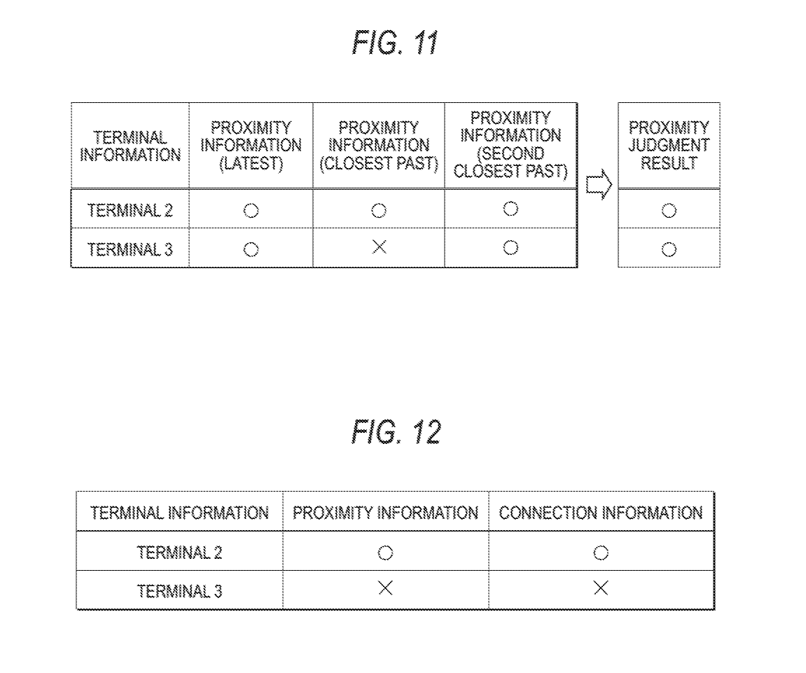

FIG. 3 shows example (1) of data that are managed by the data management unit 130. The terminals 2 and 3 are set in advance as belonging to a group. As shown in FIG. 3, the terminal 2 that is located close to the terminal 1 has proximity information and the terminal 3 that is not located dose to the terminal 1 has proximity information “x.” That is, the proximity information “∘” shown in FIG. 3 indicates that the corresponding communication terminal is located close to the terminal 1. The proximity information “x” shown in FIG. 3 indicates that the corresponding communication terminal is not located close to the terminal 1. Not only latest proximity information but also past proximity information may be stored for each of the terminals 2 and 3 (see FIG. 11). Connection information may be stored as well as terminal information and proximity information (see FIG. 13).

### <Position Information Exchange Method 1>

The position detection unit 110 acquires (exchanges) pieces of position information (stored by the memory unit 150) of the terminals 2 and 3 belonging to the same group via the data communication unit 120 and outputs pieces of current position information of the terminals 2 and 3 belonging to the same group to the memory unit 150.

The position detection unit 110 acquires current position information of the self terminal (terminal 1) in response to an instruction from the control unit 100. The memory unit 150 stores pieces of current position information of the terminals 2 and 3 belonging to the same group and current position information of the self terminal (terminal 1). The memory unit 150 may hold not only latest position information but also past position information.

No limitations are imposed on how to acquire position information; for example, position information acquired by the GPS function, position information of a wireless LAN, or position information acquired from position information of cellphone or PHS base station may be used.

FIG. 4 is a sequence diagram example (1) for update of pieces of proximity information. The terminals 1, 2, and 3 for which the group setting is made execute steps S401-S418 shown in FIG. 4 on a regular basis.

The terminal 1 acquires current position information of the self terminal (terminal 1) (step S401) and communicates the acquired current position information of the self terminal (terminal 1) to the terminals 2 and 3 for which the group setting is made (steps S402-1 and S402-2). When informed of the current position information of the terminal 1, the terminal 2 acquires position information of the self terminal (terminal 2) (step S403) and updates the proximity information of the terminal 1 that is stored by the self terminal (step S405). Likewise, when informed of the current position information of the terminal 1, the terminal 3 acquires position information of the self terminal (terminal 3) (step S404) and updates the proximity information of the terminal 1 that is stored by the self terminal (step S406).

The terminal 2 acquires current position information of the self terminal (terminal 2) (step S407), and communicates the acquired current position information of the self terminal (terminal 2) to the terminals 1 and 3 for which the group setting is made (steps S408-1 and S408-2). When informed of the current position information of the terminal 2, the terminal 1 acquires position information of the self terminal (terminal 1) (step S409) and updates the proximity information of the terminal 2 that is stored by the self terminal (step S411). Likewise, when informed of the current position information of the terminal 2, the terminal 3 acquires position information of the self terminal (terminal 3) (step S410) and updates the proximity information of the terminal 2 that is stored by the self terminal (step S412).

The terminal 3 acquires current position information of the self terminal (terminal 3) (step S413), and communicates the acquired current position information of the self terminal (terminal 3) to the terminals 1 and 2 for which the group setting is made (steps S414-1 and S414-2). When informed of the current position information of the terminal 3, the terminal 2 acquires position information of the self terminal (terminal 1) (step S416) and updates the proximity information of the terminal 3 that is stored by the self terminal (step S418). Likewise, when informed of the current position information of the terminal 3, the terminal 1 acquires position information of the self terminal (terminal 1) (step S415) and updates the proximity information of the terminal 3 that is stored by the self terminal (step S417).

As described above, when receiving current position information of one of the terminals 2 and 3 for which the group setting is made, the terminal 1 judges whether or not the other terminal 2 or 3 for which the group setting is made is located close to the self terminal (terminal 1) on the basis of a difference between the received current position information of the terminal 2 or 3 and the current position information of the self terminal (terminal 1) and updates the proximity information.

Although in FIG. 4 the terminals 1, 2, and 3 communicate position information for proximity information update in turn (steps S402-1 and S402-2, steps S408-1 and S408-2, and steps S414-1 and S414-2), it suffices that the proximity information of each terminal be updated and it is even not necessary to communicate pieces of position information in prescribed order.

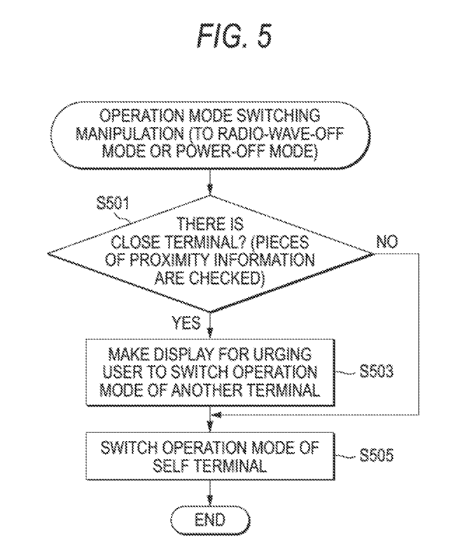

FIG. 5 is a flowchart example (1) that is executed when an operation mode switching manipulation is made. When a manipulation for switching the operation mode to the radio-wave-off mode or the power-off mode is made in the terminal 1, the control unit 100 refers to the pieces of proximity information, managed by the data management unit 130, of the terminals 2 and 3 for which the group setting is made and judges whether or not a terminal exists that is close to the self terminal (terminal 1) (step S501). If a terminal exists that is close to the self terminal (terminal 1), a transition is made to step S503. If not, a transition is made to step S505.

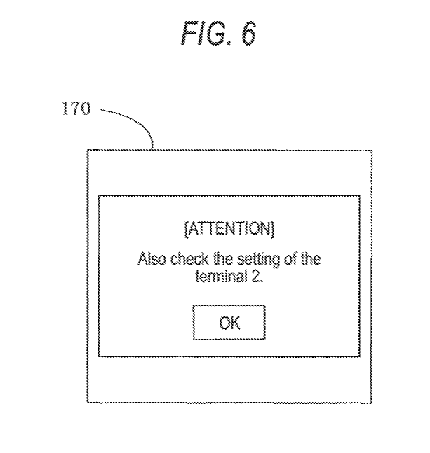

At step S503, the control unit 100 causes the display unit 170 to make a display for urging the user to switch the operation mode of the close terminal according to the operation mode of the self terminal (terminal 1) (see FIG. 6). Then a transition is made to step S505.

At step S505, the control unit 100 causes a transition of the operation mode of the self terminal (terminal 1) to the radio-wave-off mode (or power-off mode). Then the operation mode switching manipulation process is finished. The order of execution of steps S503 and S505 shown in FIG. 5 may be reversed.

FIG. 6 shows a display example (1) of the display unit 170. This is a particular display example that is made at step S503 shown in FIG. 5. As shown in FIG. 6, the control unit 100 causes the display unit 170 to make a display for urging the user to switch the operation mode of the close terminal according to the operation mode of the self terminal (terminal 1).

As described above, in the communication device according to the embodiment, if another terminal for which group setting is made is located close to the self terminal when the operation mode of the self terminal is switched, it is possible to inform the user of the self terminal that there exists another terminal whose operation mode needs to be switched according to the operation mode of the self terminal. Thus, it is possible to urge the user to pay attention so as not to fail to switch the setting of the other terminal. This is particularly effective in a case that the user has plural terminals in an area (e.g., hospital or airplane) where radio waves used for a communication may adversely affect the surroundings.

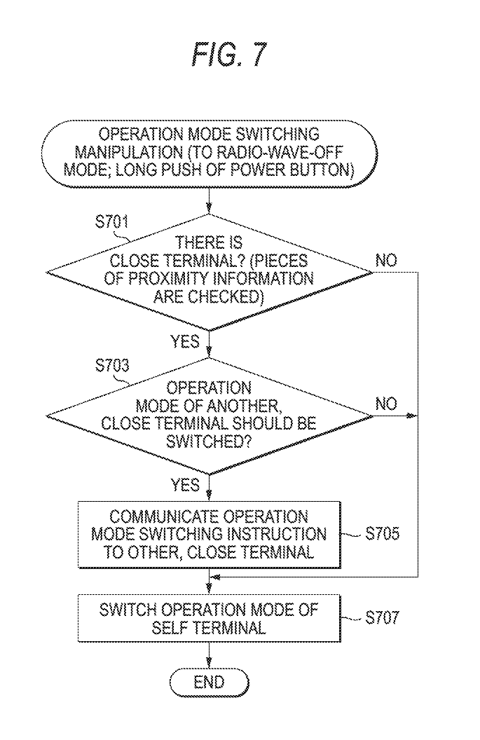

FIG. 7 is a flowchart example (2) that is executed when an operation mode switching manipulation is made. When a manipulation for switching the operation mode to the power-off mode (e.g., a long push of the power button) is made in the terminal 1, the control unit 100 refers to the pieces of proximity information, managed by the data management unit 130, of the terminals 2 and 3 for which the group setting is made and judges whether or not another terminal exists that is close to the self terminal (terminal 1) (step S701). If another terminal exists that is close to the self terminal (terminal 1), a transition is made to step S703. If not, a transition is made to step S707.

If another terminal exists that is close to the self terminal (terminal 1), the control unit 100 judges whether to switch the operation mode of the other, close terminal (step S703). If the operation mode of the other, close terminal should be switched, a transition is made to step S705. If not, a transition is made to step S707.

If the operation mode of the other, close terminal should be switched, the control unit 100 sends, to the other terminal concerned, via the data communication unit 120, a notice to the effect that its operation mode should be switched according to the operation mode of the self terminal (terminal 1). Then a transition is made to step S707.

At step S707, the control unit 100 causes a transition of the operation mode of the self terminal (terminal 1) to the radio-wave-off mode. Then the operation mode switching manipulation process is finished.

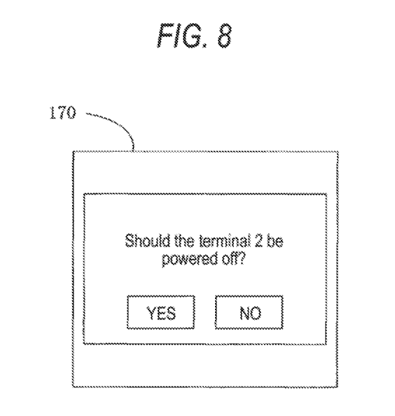

FIG. 8 shows a display example (1) of the display unit 170. This is a particular display example that is made at step S703 shown in FIG. 7. As shown in FIG. 8, the control unit 100 causes the display unit 170 to make a display for urging the user to switch the operation mode of the close terminal to the power-off mode according to the operation mode of the self terminal (terminal 1). The other terminal whose operation mode should be switched may switch its operation mode automatically upon reception of a notice to that effect. To urge the user to switch its operation mode, the other terminal whose operation mode should be switched may cause its display unit to emit light or display a message or cause it to vibrate or emit a sound.

As described above, in the communication device according to the embodiment, if another terminal for which group setting is made is located close to the self terminal when the operation mode of the self terminal is switched, it is possible to inform the user of the self terminal that there exists another terminal whose operation mode needs to be switched according to the operation mode of the self terminal. Thus, it is possible to urge the user to pay attention so as not to fail to switch the setting of the other terminal.

Furthermore, in the communication device according to the embodiment, the operation mode setting of another, dose terminal can be changed according to switching of the operation mode of the self terminal. This is particularly effective in a case that the user has plural terminals in an area (e.g., hospital or airplane) where radio waves used for a communication may adversely affect the surroundings.

### <Position Information Exchange Method 2>

Where pieces of position information are exchanged between terminals for which group setting is made according to the sequence diagram of FIG. 4, position information is acquired a large number of times. As a result, each terminal bears a heavy processing load and consumes a large amount of power. In view of this, a method for making the number of times of acquisition of position information smaller than with the sequence diagram of FIG. 4 will be described below. FIG. 9 is a sequence diagram example (2) for update of pieces of proximity information. The terminals 1, 2, and 3 for which the group setting is made execute steps S901 to S909-2 shown in FIG. 9 on a regular basis.

The terminal 1 acquires current position information of the self terminal (terminal 1) (step S901), and updates the pieces of proximity information of the other terminals 2 and 3 that are managed by the data management unit 130 (step S902). Then the terminal 1 communicates the acquired current position information of the self terminal (terminal 1) to the terminals 2 and 3 for which the group setting is made (steps S903-1 and S903-2).

The terminal 2 acquires current position information of the self terminal (terminal 2) (step S904) and updates the pieces of proximity information of the other terminals 1 and 3 that are managed in the self terminal (step S905). Then the terminal 2 communicates the acquired current position information of the self terminal (terminal 2) to the terminals 1 and 3 for which the group setting is made (steps S906-1 and S906-2).

The terminal 3 acquires current position information of the self terminal (terminal 3) (step S907) and updates the pieces of proximity information of the other terminal 1 and 2 that are managed in the self terminal (step S908). Then the terminal 3 communicates the acquired current position information of the self terminal (terminal 3) to the terminals 1 and 2 for which the group setting is made (steps S909-1 and S909-2).

Since as described above each terminal acquires position information according to the sequence diagram of FIG. 9, the number of times each terminal acquires position information can be made smaller than with the sequence diagram of FIG. 4 and hence the power consumption of each terminal can be reduced. The update of pieces of proximity information and the sending of position information may be performed in the reverse order.

### <Position Information Exchange Method 3>

Where pieces of position information are exchanged between terminals for which group setting is made according to the sequence diagram of FIG. 4, position information is acquired a large number of times. As a result, each terminal bears a heavy processing load and consumes a large amount of power. In view of this, another method for making the number of times of acquisition of position information smaller than with the sequence diagram of FIG. 4 will be described below. FIG. 10 is a sequence diagram example (3) for update of pieces of proximity information. The terminals 1, 2, and 3 for which the group setting is made execute steps S1001 to S1009 shown in FIG. 10 on a regular basis.

The terminal 1 acquires current position information of the self terminal (terminal 1) (step S1001), and updates the pieces of proximity information of the other terminals 2 and 3 that are managed by the data management unit 130 (step S1002). Then the terminal 1 communicates the acquired current position information of the self terminal (terminal 1) and latest position information of the terminal 3 communicated from the terminal 3 to the terminal 2 of the terminals 2 and 3 for which the group setting is made (steps S1003).

The terminal 2 acquires current position information of the self terminal (terminal 2) (step S1004) and updates the pieces of proximity information of the other terminals 1 and 3 that are managed in the self terminal (step S1005). Then the terminal 2 communicates the acquired current position information of the self terminal (terminal 2) and latest position information of the terminal 1 communicated from the terminal 1 to the terminal 3 of the terminals 2 and 3 for which the group setting is made (steps S1006).

The terminal 3 acquires current position information of the self terminal (terminal 3) (step S1007) and updates the pieces of proximity information of the other terminal 1 and 2 that are managed in the self terminal (step S1008). Then the terminal 3 communicates the acquired current position information of the self terminal (terminal 3) and latest position information of the terminal 2 communicated from the terminal 2 to the terminal 1 of the terminals 1 and 2 for which the group setting is made (steps S1009).

Since as described above each terminal acquires position information according to the sequence diagram of FIG. 10, the number of times each terminal acquires position information can be made smaller than with the sequence diagram of FIG. 4 and hence the power consumption of each terminal can be reduced. Furthermore, since each terminal acquires position information according to the sequence diagram of FIG. 10, pieces of position information of terminals other than a notification destination terminal can be communicated in predetermined order and hence the number of communications performed between the terminals can be reduced. This also contributes to reduction of the power consumption of each terminal. The update of pieces of proximity information and the sending of pieces of position information may be performed in the reverse order.

### [Example (2) of Management Data of Data Management Unit 130]

In the sequences shown in FIGS. 9 and 10, a time lag occurs when position information of the self terminal and pieces of position information of the other terminals. Therefore, if pieces of past proximity information of the terminals 2 and 3 are stored, the control unit 100 may judge whether each of the terminals 2 and 3 is close or not on the basis of not only the pieces of current proximity information of the terminals 2 and 3 that are stored by the memory unit 150 but also their pieces of past proximity information. A proximity judging method using pieces of latest proximity information and pieces of past proximity information will be described with reference to FIG. 11. FIG. 11 shows example (2) of management data of the data management unit 130.

As shown in FIG. 11, pieces of latest proximity information and two sets of pieces of past proximity information of the terminals 2 and 3 are managed by the data management unit 130. The control unit 100 judge whether or not each of the terminals 2 and 3 is close to the terminal 1 on the basis of the pieces of latest proximity information and the two sets of pieces of past proximity information of the terminals 2 and 3 that are managed by the data management unit 130. In this figure, the latest proximity information and the two pieces of past proximity information of the terminal 2 are “∘” Therefore, the control unit 100 judges that the terminal 2 is close to the self terminal (terminal 1). On the other hand, as for the terminal 3, the closest past proximity information is “x” and the latest proximity information and the second closest past proximity information are “∘.” Therefore, the control unit 100 judges that the terminal 3 is also close to the self terminal (terminal 1). As described above with reference to FIG. 11, a judgment as to whether or not another terminal for which group setting is made is close to the self terminal may be made on the basis of differences between several past pieces of position information (i.e., pieces of proximity information)

### [Example (3) of Management Data of Data Management Unit 130]

The data management unit 130 manages pieces of terminal information and corresponding pieces of proximity information. Where a communication may occur that is directed to a terminal whose operation mode is the power-off mode, an appropriate measure is to hold, in addition to the pieces of terminal information and the corresponding pieces of proximity information, pieces of connection information indicating whether or not the self terminal (terminal 1) is connected to the other terminals 2 and 3 for which the group setting is made via the external network 4. The use of those pieces of connection information makes it possible to solve, for example, a problem that when the operation mode of another terminal 2 is switched immediately after switching of the operation mode of the self terminal (terminal 1) an (unnecessary) attention message is displayed when the switching is made in the terminal 2 as well as when the switching is made in the terminal 1.

FIG. 12 shows example (3) of management data of data management unit 130. As shown in FIG. 12, the data management unit 130 manages not only pieces of terminal information and corresponding pieces of proximity information but also pieces of connection information indicating whether or not the self terminal (terminal 1) is connected to the other terminals 2 and 3 via the external network 4. The proximity information and the connection information of the terminal 2 are “∘,” and the proximity information and the connection information of the terminal 3 are “x.” Therefore, by referring to the pieces of connection information, the terminal 1 communicates position information only to the terminal 2 being in a connected state. In this manner, an unnecessary communication to the terminal 3 which is in a disconnected state can be prevented.

FIG. 13 is a flowchart example (3) that is executed when an operation mode switching manipulation is made. When a manipulation for switching the operation mode to the power-off mode (e.g., a long push of the power button) is made in the terminal 1, the control unit 100 refers to the pieces of proximity information, managed by the data management unit 130, of the terminals 2 and 3 for which the group setting is made and judges whether or not another terminal exists that is close to the self terminal (terminal 1) (step S1301). If another terminal exists that is close to the self terminal (terminal 1), a transition is made to step S1303. If not, a transition is made to step S1305.

The control unit 100 refers to the pieces of proximity information and the pieces of connection information managed by the data management unit, and causes the display unit 170 to make a display for urging the user to switch the operation mode of the terminal that is close to the terminal 1 and in a connected state according to the operation mode (power-off mode) of the self terminal (terminal 1) (step S1303). Then a transition is made to step S1305.

The control unit 100 communicates a notice to the effect the self terminal (terminal 1) going to be rendered in a disconnected state (power-off mode) to all of the other terminals that are in a connected state via the data communication unit 120 (step S1305). Then a transition is made to step S1307.

The control unit 100 switches the operation mode of the self terminal to the power-off mode. Then the operation mode switching manipulation process is finished.

With the above process, even if a manipulation for switching the operation mode of the terminal 2 being in a connected state is made immediately after power-off of the self terminal 1, the display unit of the terminal makes no display relating to the disconnected terminal 1. When an operation mode transition is made and recovery is made from a disconnected state, terminals for which the group setting is made are informed of the recovery of connection and the connection states in those terminals are updated. As a result, position information exchange with the once disconnected terminals is restarted. When plural terminals are powered on simultaneously and connections are restored, recovery notices may pass each other. In view of such a possibility, a connection recovery notice may be sent plural times at the time of power-on.

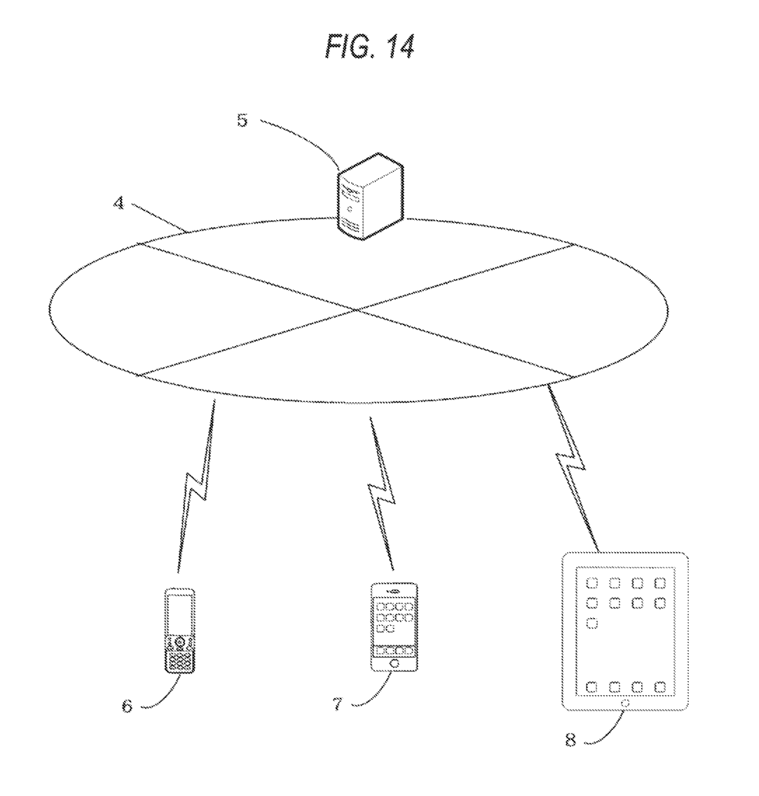

### Embodiment 2

Whereas in the first embodiment the communication system is formed which includes the plural terminals, as shown in FIG. 14 a communication system can be realized in which a server device 5 is provided on the side of an external network 4 to which terminals 6-8 are connected. The terminals 6-8 and the server device 5 can communicate with each other over the external network 4.

FIG. 14 is a schematic diagram showing the configuration of a communication system according to a second embodiment of the invention. The server device 5 broadcasts a position information acquisition request to all terminals for which the group setting is made over the external network 4 and communicates, to the terminal 6-8, pieces of proximity information that are generated on the basis of position information responses that are responses to the position information acquisition request.

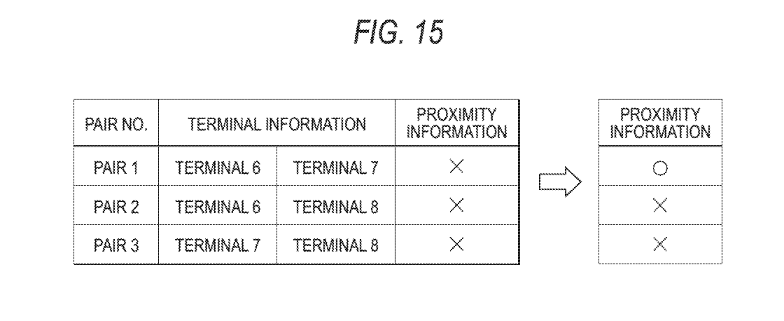

FIG. 15 shows an example of data that are managed by the server device 5. The server device 5 manages pieces of information indicating group-registered pairs of terminals and pieces of proximity information. As shown in FIG. 15, the proximity information of a pair 1 formed by the terminals 6 and 7 is “x,” the proximity information of a pair 2 formed by the terminals 6 and 8 is “x,” and the proximity information of a pair 3 formed by the terminals 7 and 8 is “x.”

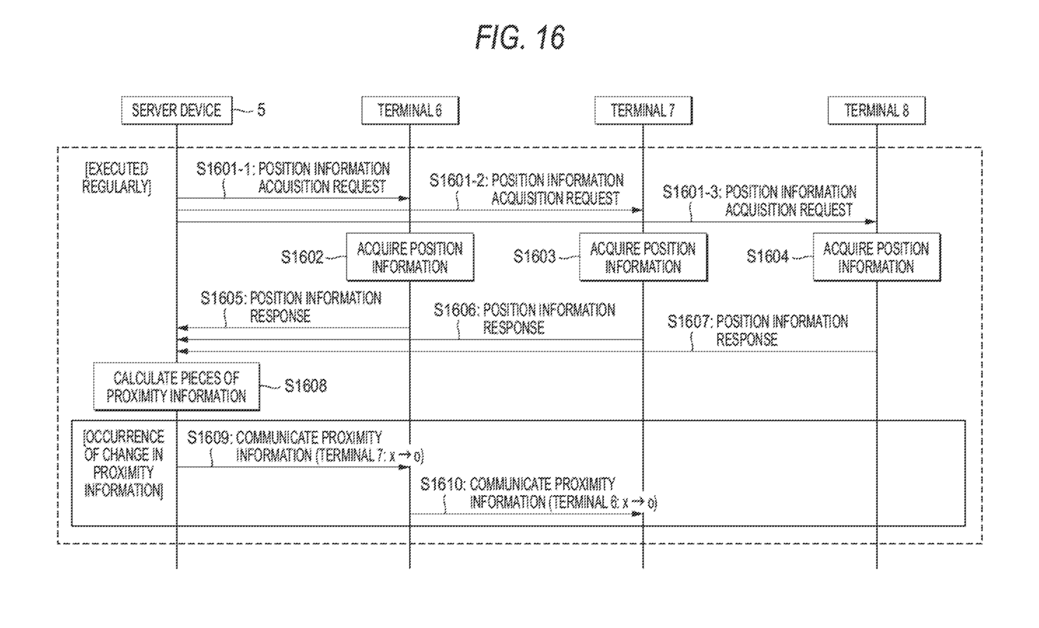

In the following, a description will be made of a case that the server device 5 receives a response to a position information acquisition request and, as a result, the proximity information of a pair 1 formed by the terminals 6 and 7 is changed to (see FIG. 15). FIG. 16 is a sequence diagram example (4) for update of pieces of proximity information. The server device 5 and the terminals 6-8 execute steps S1601-1 to S1610 shown in FIG. 16 on a regular basis.

The server device 5 communicates a position information acquisition request to all the terminals 6-8 for which the group setting is made (steps S1601-1, S1601-2, and S1601-3).

When receiving the position information acquisition request from the server device 5, the terminal 6 acquires current position information of the self terminal (step S1602). Then the terminal 6 returns the current position information of the self terminal to the server device 5 (step S1605: position information response).

Likewise, when receiving the position information acquisition request from the server device 5, the terminal 7 acquires current position information of the self terminal (step S1603). Then the terminal 7 returns the current position information of the self terminal to the server device 5 (step S1606: position information response).

When receiving the position information acquisition request from the server device 5, the terminal 8 acquires current position information of the self terminal (step S1604). Then the terminal 8 returns the current position information of the self terminal to the server device 5 (step S1607: position information response).

When receiving the pieces of current position information from all the terminals 6-8 for which the group setting is made, the server device 5 generates pieces of proximity information of the respective pairs of terminals (step S1608).

If generated proximity information is different from proximity information generated last time, the server device 5 informs the corresponding pair of terminals that the proximity information has changed (step S1609 and S1610). In this embodiment, since the proximity information of the terminals 6 and 7 has changed from “x” to “∘,” the server device 5 communicates the updated proximity information to each of the terminals 6 and 7.

The server device 5 may manage pieces of connection information of terminals for which the group setting is made in the same manner as in the first embodiment. This mode can be realized without changing pieces of information to be managed in each terminal because it suffices that the server device 5 communicate proximity information to each terminal in such a manner that it contains connection information.

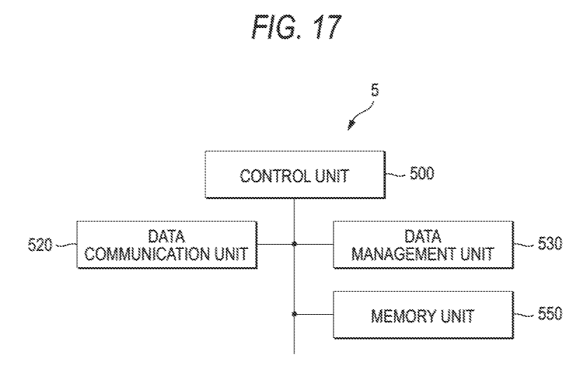

FIG. 17 is a block diagram showing the configuration of the server device 5. As shown in FIG. 17, the server device 5 is equipped with a control unit 500, a data communication unit 520, a data management unit 530, and a memory unit 550.

The control unit 500 is composed of a central processing unit (CPU), a timer, a memory, etc. The control unit 500 controls the entire server device 5, that is, controls the data communication unit 520, the data management unit 530, the manipulation unit 540, and the memory unit 550.

The control unit 500 communicates a position information acquisition request to all the terminals 6-8 for which the group setting is made via the data communication unit 520. The control unit 500 acquires current position information of each of the terminals for which the group setting is made from each terminal via the data communication unit 520. The current position information of each terminal is stored by the memory unit 550.

The control unit 500 refers to the pieces of current position information of the terminals of each group that are stored by the memory unit 550, and updates the pieces of proximity information of the terminals of each group that are stored by the data management unit 530 (see FIG. 15). More specifically, the control unit 500 judges whether or not each terminal is located close to the other terminal of the same group on the basis of a difference between the pieces of position information of the terminals that are currently stored by the memory unit 550, and updates the proximity information of the terminals of each group that is managed by the data management unit 530.

The control unit 500 communicates the updated proximity information to the other terminal that belongs to the same pair as each proximity-information-updated terminal does.

Referring to FIG. 16, the terminal 6 is informed by the server device 5 of the updated proximity information “∘” of the terminal 7 belonging to the same pair and the terminal 7 is informed by the server device 5 of the updated proximity information “∘” of the terminal 6 belonging to the same pair. In switching the operation mode of the self terminal, if judging that the other terminal is located close to the self terminal on the basis of such proximity information, each terminal makes a display for urging the user to switch the operation mode of the other terminal according to the new operation mode of the self terminal.

Referring to FIG. 15, since the terminals 6 and 7 which constitute a pair are located dose to each other, the terminal 6 causes its display unit 1870 to display a message for urging the user to switch the operation mode of the terminal 7 according to the new operation mode of the self terminal (terminal 6).

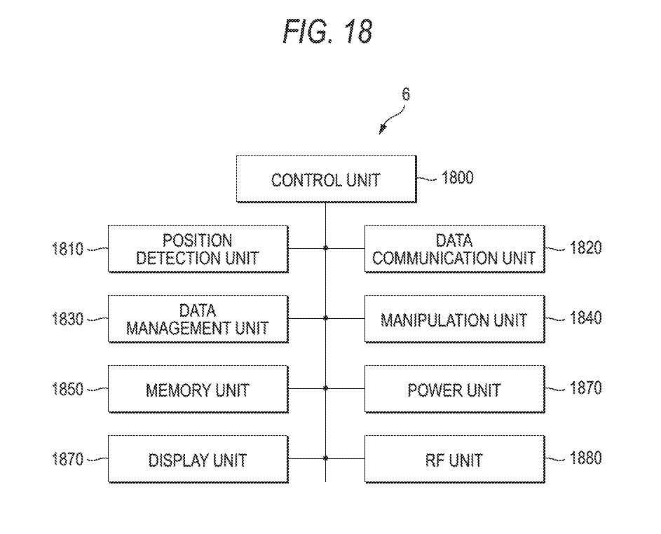

FIG. 18 is a block diagram showing the configuration of the terminal 6. Although the terminal 6 will be described as an example terminal with reference to FIG. 18, the other terminals 7 and 8 (see FIG. 14) have similar configurations. As shown in FIG. 18, the terminal 6 is equipped with a control unit 1800, a position detection unit 1810, a data communication unit 1820, a data management unit 1830, a manipulation unit 1840, a memory unit 1850, a power unit 1860, the display unit 1870, and an RF unit 1880.

Components having common functions of a portable terminal, such as an antenna, a microphone, and a battery, are omitted in FIG. 18.

The control unit 1800 is composed of a central processing unit (CPU), a timer, a memory, etc. The control unit 1800 controls the entire terminal 6, that is, controls the position detection unit 1810, the data communication unit 1820, the data management unit 1830, the manipulation unit 1840, the memory unit 1850, the power unit 1860, the display unit 1870, the RF unit 1880, etc.

When receiving a position information acquisition request from the server device 5, the data communication unit 1820 sends current position information of the self terminal (terminal 6) that is output from the position detection unit 1810 to the server device 5 as a position information response over the external network 4 under the control of the control unit 1800 (see FIG. 16).

The control unit 1800 switches the operation mode of the self terminal (terminal 6) in response to an input manipulation performed on the manipulation unit 1840 or an operation mode switching instruction that is communicated from the server device 5. In this embodiment, three operation modes, that is, a radio-wave-off mode in which radio waves are not emitted to the outside, a power-off mode in which the power is kept off, and a normal mode in which an ordinary operation is performed by emitting radio waves to the outside, are assumed. However, the operation modes are not limited to them.

In switching from the normal mode or the radio-wave-off mode to the power-off mode, the control unit 1800 performs a control for shutting off the power supplied from the power unit 1860. In switching from the normal mode or the power-off mode to the radio-wave-off mode, the control unit 1800 controls the RF unit 1880 so as to prohibit emission of radio waves to the outside with power supplied from the power unit 1860.

The manipulation unit 1840 receives a user input manipulation and outputs a signal corresponding to the input manipulation to the control unit 1800. The manipulation unit 1840 is an input interface such as input keys (e.g., power button) or a touch panel.

The display unit 1870 displays output information corresponding to a user input manipulation under the control of the control unit 1800. The display unit 1870 is an output interface such as a touch panel screen or a liquid crystal screen. The display unit 1870 may be a touch panel that also serves as the manipulation unit 1840.

The position detection unit 1810 acquires current position information of the self terminal (terminal 6) under the control of the control unit 1800. The current position information of the self terminal (terminal 6) is stored by the memory unit 1850. Not only the latest position information of the self terminal but also position information detected in the past of the self terminal may be stored by the memory unit 1850.

No limitations are imposed on how to acquire position information; for example, position information acquired by the GPS function, position information of a wireless LAN, or position information acquired from position information of a cellphone or PHS base station may be used.

The data management unit 1830 stores a list of plural terminals that are paired in advance (hereinafter referred to as pieces of terminal information) and pieces of proximity information for judgment as to whether or not these terminals (terminals 7 and 8) are located close to the self terminal (terminal 1). Although in this embodiment plural terminals are set in advance as pairs, a pair of terminals can also be set through manual registration, registration by a short-distance wireless communication or a mail, registration using a personal computer, a storage device, or the like, or by a like method. Referring to FIG. 16, for example, the terminal 6 is informed by the server device 5 of updated proximity information “∘” of the terminal 7 belonging to the same pair and the terminal 7 is informed by the server device 5 of updated proximity information “∘” of the terminal 6 belonging to the same pair. Therefore, in switching the operation mode of the self terminal, if judging that the other terminal is located close to the self terminal on the basis of such proximity information, each of the terminals 6 and 7 makes a display for urging the user to switch the operation mode of the other terminal according to the new operation mode of the self terminal.

As described above, in the second embodiment, the server device 5 manages pieces of proximity information of terminals for which the group setting is made. When proximity information is updated and changed, the server device 5 communicates updated proximity information to the associated terminal. Implementing, in the above-described manner, the proximity information update function in the server device 5 located on the external network 4 makes it possible to realize reduction of the load and the power consumption of each terminal.

In the embodiment, terminals are paired in the server device 5 and proximity information is managed for the terminals constituting each pair. However, the same function can be implemented by processing that pieces of position information of respective terminals are recorded and whether proximity information has been changed or not is judged through a comparison between differences from newly received pieces of position information of terminals, or any of other similar methods. The management method is not limited to the one employed in the embodiment.

### Embodiment 3

In a third embodiment, as in the second embodiment, a communication system is formed in which plural terminals and a server device can communicate with each other over an external network.

FIG. 19 is a schematic diagram showing the configuration of a communication system according to the third embodiment of the invention. A server device 15 broadcasts a position information acquisition request to pre-registered terminals 16, 17, 18, and 19 over an external network 4 and generates pieces of proximity information on the basis of position information responses that are responses to the position information acquisition request. Unlike in the first and second embodiments, group setting need not be made for the terminals 16-19 in advance.

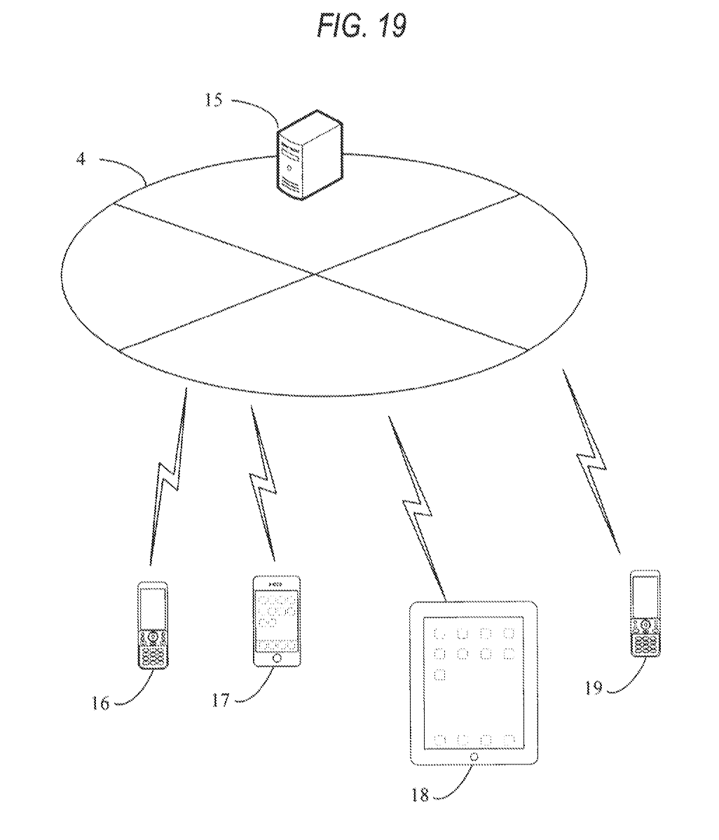

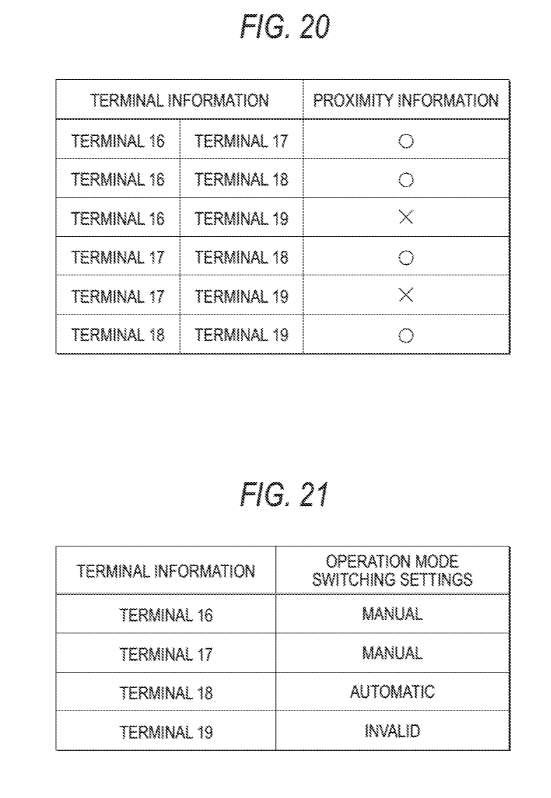

The server device 15 manages pieces of information indicating pairs of registered terminals and corresponding pieces of proximity information. FIG. 20 shows an example of data relating to pieces of information indicating pairs of terminals and pieces of proximity information that are managed by the server device 15. In this embodiment, the proximity information of every conceivable pair of terminals selected from the terminals registered in the server device 15 is managed using symbols “∘” (close to each other) and (not dose to each other). In the example of FIG. 20, the terminals 16-19 are registered in the server device 15. Therefore, the server device 15 manages proximity information “∘” of a pair that is formed by the terminals 16 and 17, proximity information “∘” of a pair that is formed by the terminals 16 and 18, proximity information “x” of a pair that is formed by the terminals 16 and 19, proximity information “∘” of a pair that is formed by the terminals 17 and 18, proximity information “x” of a pair that is formed by the terminals 17 and 19, and proximity information “∘” of a pair that is formed by the terminals 18 and 19.

Furthermore, the server device 15 manages operation mode switching settings of the respective registered terminals. The operation mode switching settings are “automatic,” “manual,” and “invalid.” FIG. 21 shows an example of data relating to the operation mode switching settings of the respective terminals that are managed by the server device 15. In the example of FIG. 21, the operation mode switching settings of the terminals 16 and 17 registered in the server device 15 are set to “manual,” the operation mode switching setting of the terminal 18 is set to “automatic,” and the operation mode switching setting of the terminal 19 is set to “invalid.”

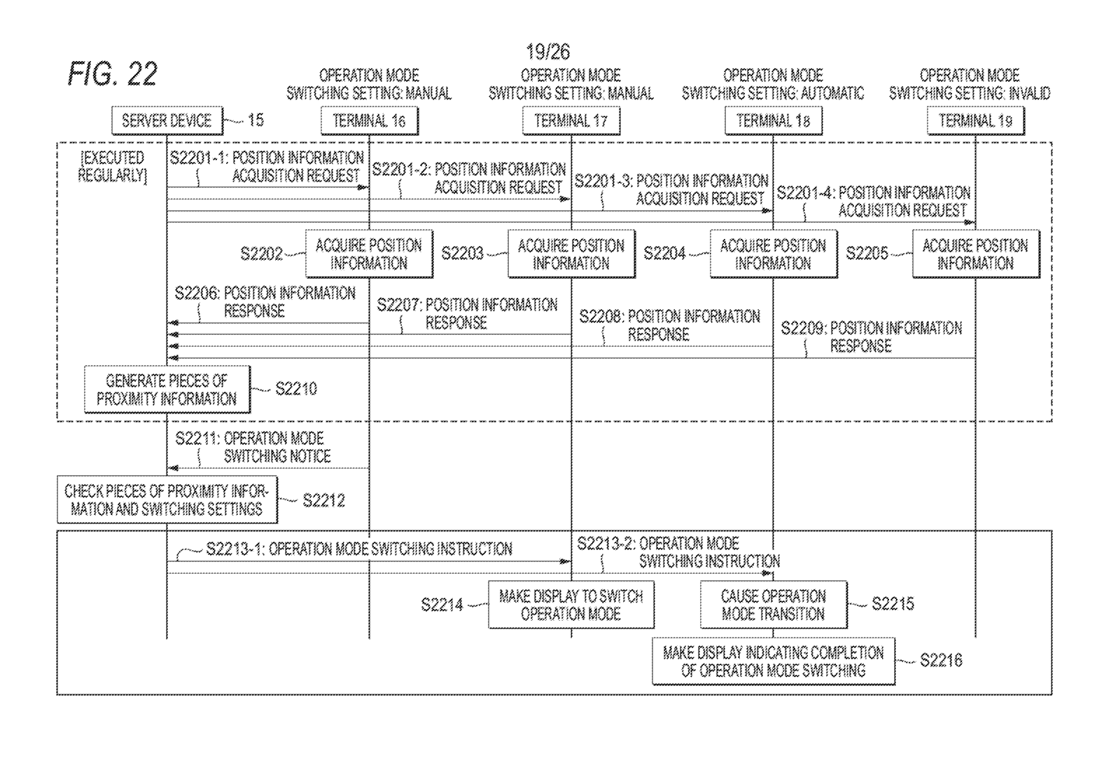

FIG. 22 is a sequence diagram example (4) showing a process that is executed by the communication system according to the third embodiment. The server device 15 and the terminals 16-19 execute steps S2201-1 to S2210 shown in FIG. 22 on a regular basis.

The server device 15 communicates a position information acquisition request to all the registered terminals 16-18 (steps S2201-1, S2201-2, S2201-3, and S2201-4).

When receiving the position information acquisition request from the server device 15, the terminal 16 acquires current position information of the self terminal (step S2202). Then the terminal 6 sends a position information response containing the current position information of the self terminal to the server device 15 (step S2206). Likewise, when receiving the position information acquisition request from the server device 15, the terminal 17 acquires current position information of the self terminal (step S2203). Then the terminal 17 sends a position information response containing the current position information of the self terminal to the server device 15 (step S2207).

Likewise, when receiving the position information acquisition request from the server device 15, the terminal 18 acquires current position information of the self terminal (step S2204). Then the terminal 18 sends a position information response containing the current position information of the self terminal to the server device 15 (step S2208). Likewise, when receiving the position information acquisition request from the server device 15, the terminal 19 acquires current position information of the self terminal (step S2205). Then the terminal 19 sends a position information response containing the current position information of the self terminal to the server device 15 (step S2209).

Each of the terminals 16-19 may acquire current position information of the self terminal voluntarily as well as when it receives a position information acquisition request from the server device 15.

When receiving the position information responses from the terminals 16-19, the server device 15 generates pieces of proximity information for the respective pairs of terminals on the basis of the pieces of current position information contained in the position information responses (step S2210).

If the operation mode of the terminal 16, for example, is switched later by the user, the terminal 16 sends an operation mode switching notice to the server device 15 (step S2211). The server device 15 checks the pieces of proximity information generated at step S2210, determines terminals that are close to the terminal 16 from which the operation mode switching notice has been received, and checks the operation mode switching settings of the thus-determined, respective terminals (step S2212). Then the server device 15 sends an operation mode switching instruction containing the content of the operation mode switching that was performed on the terminal 16 to each of the terminals 17 and 18 whose operation mode switching settings are not “invalid” among the terminals that are close to the terminal 16 (steps S2213-1 and S2213-2).

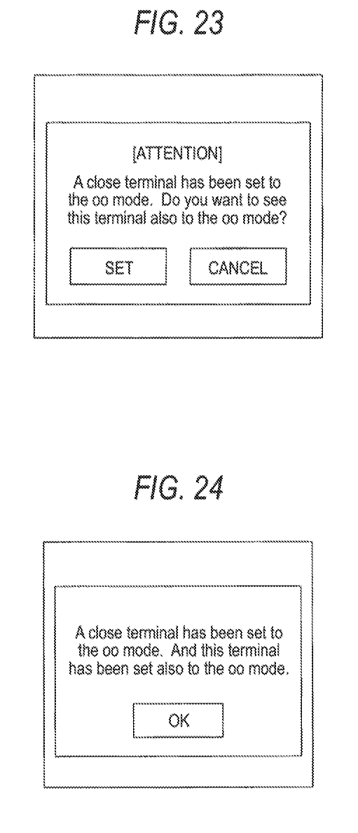

Since the operation mode switching setting that is set for the self terminal is “manual,” when receiving the operation mode switching instruction from the server device 15, the terminal 17 causes the display unit to display a picture for urging the user to switch the operation mode (step S2214). FIG. 23 shows an example picture that is displayed at step S2214 when a terminal whose operation mode switching setting is “manual” receives an operation mode switching instruction.

On the other hand, since the operation mode switching setting that is set for the self terminal is “automatic,” when receiving the operation mode switching instruction from the server device 15, the terminal 18 makes a transition to the new operation mode indicated by the information contained in the operation mode switching instruction (S2215). Then the terminal 18 causes the display unit to display a picture indicating that the operation mode has been switched (step S2216). FIG. 24 shows an example picture that is displayed at step S2216 when a terminal whose operation mode switching setting is “automatic” receives an operation mode switching instruction.

The server device 15 may send, to each terminal, an operation mode switching instruction containing information indicating the operation mode switching setting “manual” or “automatic.” In this case, it is not necessary that an operation mode switching setting be stored in each terminal. Where the operation mode switching instruction does not contain information indicating “manual” or “automatic,” each of the operation mode switching settings managed by the server device 15 may be either “valid” or “invalid.” That is, a terminal that has received an operation mode switching instruction operates according to which of “manual” and “automatic” is stored as the operation mode switching setting in the self terminal.

Until a lapse of a prescribed time from the sending of the operation mode switching instructions to the terminals 17 and 18 at step S2213-1 and S2213-2, the server device 15 disregards an operation mode switching notice even if it is received from the terminal 17 or 18.

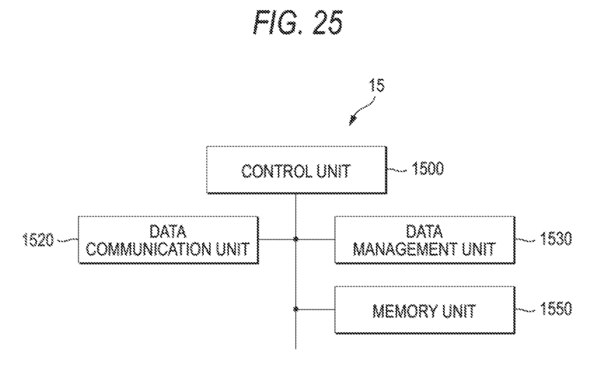

FIG. 25 is a block diagram showing the configuration of the server device 15. As shown in FIG. 25, the server device 15 is equipped with a control unit 1500, a data communication unit 1520, a data management unit 1530, and a memory unit 1550.

The control unit 1500 is composed of a central processing unit (CPU), a timer, a memory, etc. The control unit 1500 controls the entire server device 15, that is, controls the data communication unit 1520, the data management unit 1530, the manipulation unit 1540, and the memory unit 1550.

The control unit 1500 communicates a position information acquisition request to all the registered terminals 6-8 via the data communication unit 1520. The control unit 1500 receives a position information response from each registered terminal via the data communication unit 1520. The control unit 1500 stores, in the memory unit 1550, current position information of each terminal contained in each received position information response.

The control unit 1500 refers to the pieces of current position information of the respective terminals that are stored by the memory unit 1550, and updates the pieces of proximity information of the respective pairs of terminals that are stored by the data management unit 1530 (see FIG. 20). More specifically, the control unit 1500 judges whether or not the two terminals constituting each pair are located close to each other on the basis of a difference between the pieces of position information of those terminals that are currently stored by the memory unit 1550, and updates the proximity information of each pair that is managed by the data management unit 1530. The control unit 1500 judges that two terminals are dose to each other if the difference between pieces of position information of the terminals is smaller than a threshold value.

Furthermore, the control unit 1500 acquires the operation mode switching settings that are set in all the registered terminals 16-19 in advance from those terminals, respectively, via the data communication unit 1520. The acquired operation mode switching settings of the respective terminals are stored in the data management unit 1530.

When an operation mode switching notice is received from one of the registered terminals, the control unit 1500 refers to the pieces of proximity information of the respective pairs and the operation mode switching settings of the respective terminals that are managed by the data management unit 1530 and selects terminals whose operation mode switching settings are not “invalid” from terminals that are dose to the terminal from which the operation mode switching notice has been received. Then the control unit 1500 sends an operation mode switching instruction to each of the selected terminals via the data communication unit 520.

Until a lapse of a prescribed time from the sending of the operation mode switching instructions to the selected terminals, the control unit 1500 disregards an operation mode switching notice even if it is received from a terminal to which the operation mode switching instruction was sent.

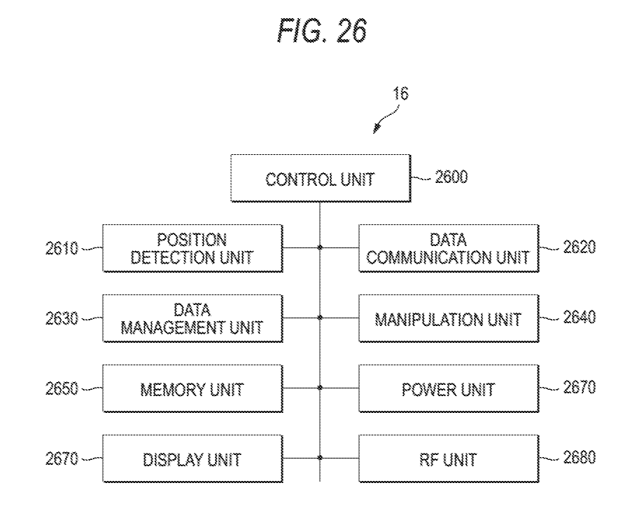

FIG. 26 is a block diagram showing the configuration of the terminal 16. Although the terminal 16 will be described as an example terminal with reference to FIG. 26, the other terminals 17-19 (see FIG. 19) have similar configurations. As shown in FIG. 26, the terminal 16 is equipped with a control unit 2600, a position detection unit 2610, a data communication unit 2620, a data management unit 2630, a manipulation unit 2640, a memory unit 2650, a power unit 2660, the display unit 2670, and an RF unit 2680.

Components having common functions of a portable terminal, such as an antenna, a microphone, and a battery, are omitted in FIG. 26.

The control unit 2600 is composed of a central processing unit (CPU), a timer, a memory, etc. The control unit 2600 controls the entire terminal 16, that is, controls the position detection unit 2610, the data communication unit 2620, the data management unit 2630, the manipulation unit 2640, the memory unit 2650, the power unit 2660, the display unit 2670, the RF unit 2680, etc.

When receiving a position information acquisition request from the server device 15, the data communication unit 2620 sends current position information of the self terminal (terminal 16) that is output from the position detection unit 2610 to the server device 15 as a position information response over the external network 4 under the control of the control unit 2600 (see FIG. 22). Furthermore, the data communication unit 2620 receives an operation mode switching instruction transmitted from the server device 15.

The control unit 2600 switches the operation mode of the self terminal (terminal 16) in response to an input manipulation performed on the manipulation unit 2640 or an operation mode switching instruction that is communicated from the server device 15. In this embodiment, four operation modes, that is, a manner mode (vibration mode) in which such a sound as a ringtone is not emitted, a radio-wave-off mode in which radio waves are not emitted to the outside, a power-off mode in which the power is kept off, and a normal mode in which an ordinary operation is performed by emitting radio waves to the outside, are assumed. However, the operation modes are not limited to them.

In switching from the normal mode or the radio-wave-off mode to the power-off mode, the control unit 2600 performs a control for shutting off the power supplied from the power unit 2660. In switching from the normal mode or the power-off mode to the radio-wave-off mode, the control unit 2600 controls the RF unit 2680 so as to prohibit emission of radio waves to the outside with power supplied from the power unit 2660. At this time, the control unit 2600 sends an operation mode switching notice to the server device 15 via the data communication unit 2620 before switching the operation mode of the self terminal.

The manipulation unit 2640 receives a user input manipulation and outputs a signal corresponding to the input manipulation to the control unit 2600. The manipulation unit 2640 is an input interface such as input keys (e.g., power button) or a touch panel.

The display unit 2670 displays output information corresponding to a user input manipulation under the control of the control unit 2600. The display unit 2670 is an output interface such as a touch panel screen or a liquid crystal screen. The display unit 2670 may be a touch panel that also serves as the manipulation unit 2640.

The position detection unit 2610 acquires current position information of the self terminal (terminal 16) under the control of the control unit 2600. The current position information of the self terminal (terminal 16) is stored by the memory unit 2650. Not only the latest position information of the self terminal but also position information detected in the past of the self terminal may be stored by the memory unit 2650.

No limitations are imposed on how to acquire position information; for example, position information acquired by the GPS function, position information of a wireless LAN, or position information acquired from position information of a cellphone or PHS base station may be used.

As described above, in the third embodiment, the server device 15 manages pieces of information indicating pairs of terminals belonging to registered terminals, pieces of proximity information of those respective pairs, and operation mode switching settings of the respective registered terminals. When receiving an operation mode switching notice from one of the registered terminals, the server device 15 sends an operation mode switching instruction to each of terminals whose operation mode switching settings are not “invalid” among terminals that are close to the terminal from which the operation mode switching notice has been received. Receiving the operation mode switching instruction, the terminal performs processing relating to operation mode switching according to the operation mode switching setting that is set in the self terminal.

As described above, when the operation mode is switched in one of plural terminals that are close to each other, processing relating to operation mode switching is performed in each of the other close terminals according to its operation mode switching setting. Therefore, it is not necessary for the user of each of the plural close terminals to switch the operation mode by manipulating the self terminal. For example, where the operation mode switching settings of the terminals of all persons attending a conference are set to “automatic,” if one of those persons switches the operation mode, the operation modes of the terminals of the other persons are switched without manipulations by the other persons (users). The kinds of operation mode switching for which operation mode switching instructions (described above) are to be sent may be restricted as exemplified by a rule that operation mode switching instructions are not sent to the other close terminals in the case of switching from the manner mode to the normal mode.

In the embodiment, until a lapse of the prescribed time from the sending of operation mode switching instructions to terminals, the server device 15 disregards an operation mode switching notice even if it is received from a terminal to which the operation mode switching instruction was sent. Therefore, even if plural users have switched the operation modes of their own terminals at time points that are close to each other, responsive processing is performed only for the earliest operation mode switching, as a result of which confusion relating to operation modes and like problems can be avoided.

### Embodiment 4

In a fourth embodiment, as in the third embodiment, a communication system is formed in which plural terminals and a server device can communicate with each other over an external network.

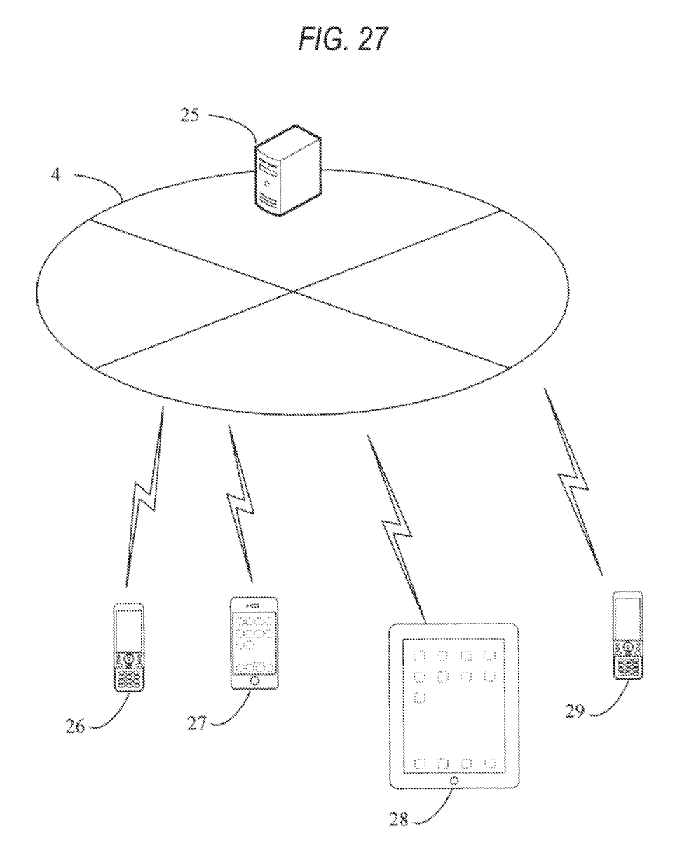

FIG. 27 is a schematic diagram showing the configuration of a communication system according to the fourth embodiment of the invention. A server device 25 broadcasts a position information acquisition request to pre-registered terminals 26, 27, 28, and 29 over an external network 4, and stores position information responses that are responses to the position information acquisition request. Unlike in the first and second embodiments, group setting need not be made for the terminals 26-29 in advance.

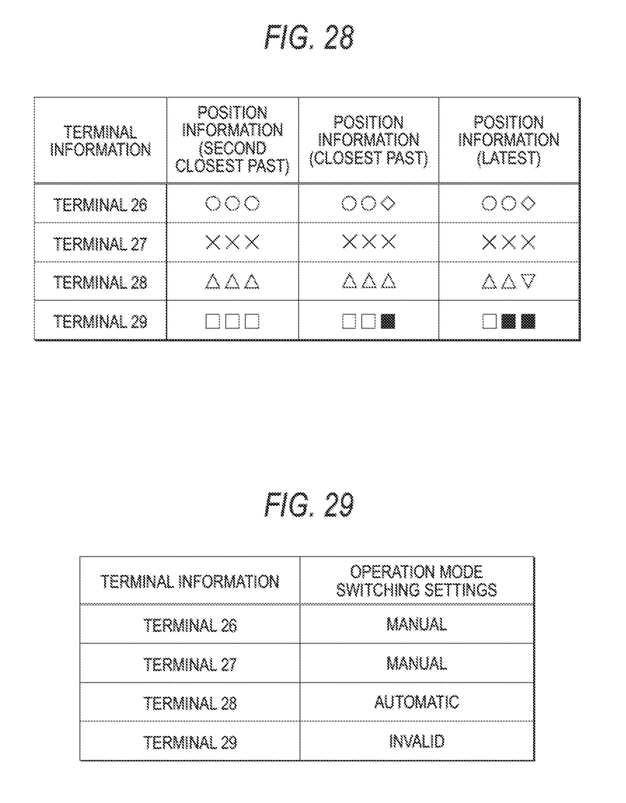

The server device 25 manages, for each terminal, in time series, pieces of position information indicated by the position information responses acquired from each registered terminal. FIG. 28 shows an example of data relating to position information that are managed by the server device 25. In this embodiment, pieces of acquired position information are managed in times series for each registered terminal. In the example of FIG. 28, the terminals 26-29 are registered in the server device 25 and latest position information and past two pieces of position information of each are managed.

Furthermore, the server device 25 manages operation mode switching settings of the respective registered terminals. The operation mode switching settings are “automatic,” “manual,” and “invalid.” FIG. 29 shows an example of data relating to the operation mode switching settings of the respective terminals that are managed by the server device 25. In the example of FIG. 29, the operation mode switching settings of the terminals 26 and 27 registered in the server device 25 are set to “manual,” the operation mode switching setting of the terminal 28 is set to “automatic,” and the operation mode switching setting of the terminal 29 is set to “invalid.”

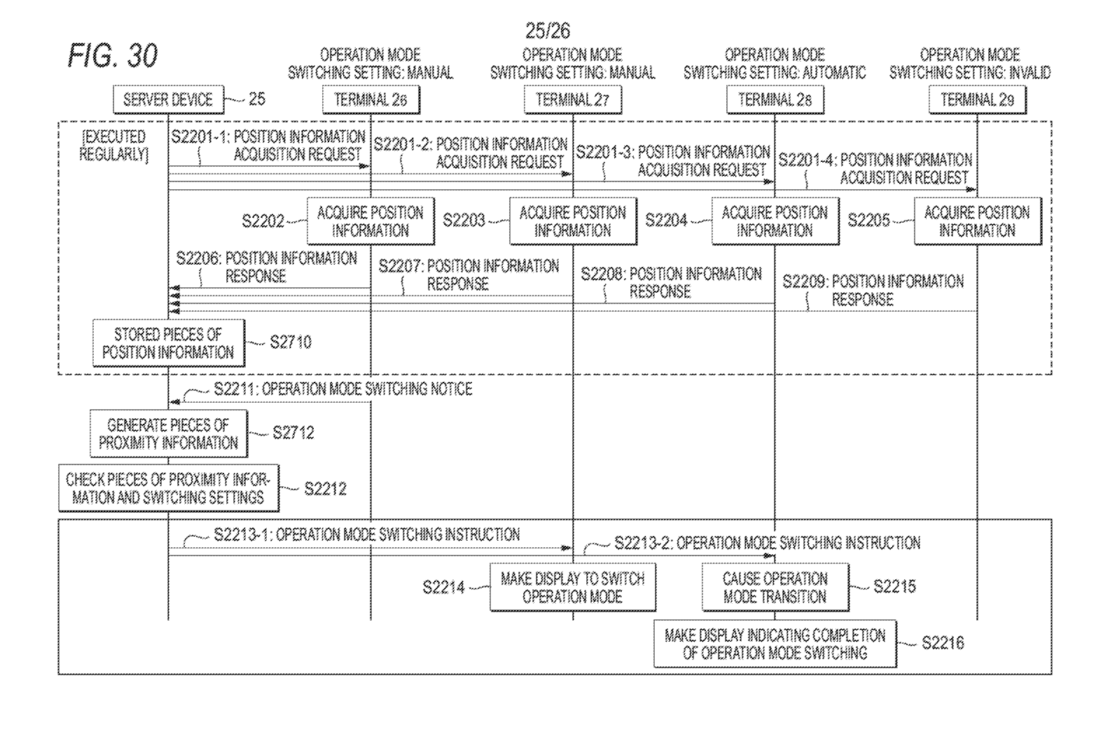

FIG. 30 is a sequence diagram example showing a process that is executed by the communication system according to the fourth embodiment. In FIG. 30, steps having the same ones in FIG. 22 are given the same reference symbols as the latter. The server device 25 and the terminals 26-29 execute steps S2201-1 to S2209 and step S2710 shown in FIG. 30 on a regular basis.

The server device 25 communicates a position information acquisition request to all the registered terminals 26-28 (steps S2201-1, S2201-2, S2201-3, and S2201-4).

When receiving the position information acquisition request from the server device 25, the terminal 26 acquires current position information of the self terminal (step S2202). Then the terminal 26 sends a position information response containing the current position information of the self terminal to the server device 25 (step S2206). Likewise, when receiving the position information acquisition request from the server device 25, the terminal 27 acquires current position information of the self terminal (step S2203). Then the terminal 27 sends a position information response containing the current position information of the self terminal to the server device 25 (step S2207).

Likewise, when receiving the position information acquisition request from the server device 25, the terminal 28 acquires current position information of the self terminal (step S2204). Then the terminal 28 sends a position information response containing the current position information of the self terminal to the server device 25 (step S2208). Likewise, when receiving the position information acquisition request from the server device 25, the terminal 29 acquires current position information of the self terminal (step S2205). Then the terminal 29 sends a position information response containing the current position information of the self terminal to the server device 25 (step S2209).

Each of the terminals 26-29 may acquire current position information of the self terminal voluntarily as well as when it receives a position information acquisition request from the server device 25.

When receiving the position information responses from the terminals 26-29, the server device 25 stores the pieces of current position information contained in the position information responses so as to form time-series data as shown in FIG. 28 for the respective terminals (step S2710).

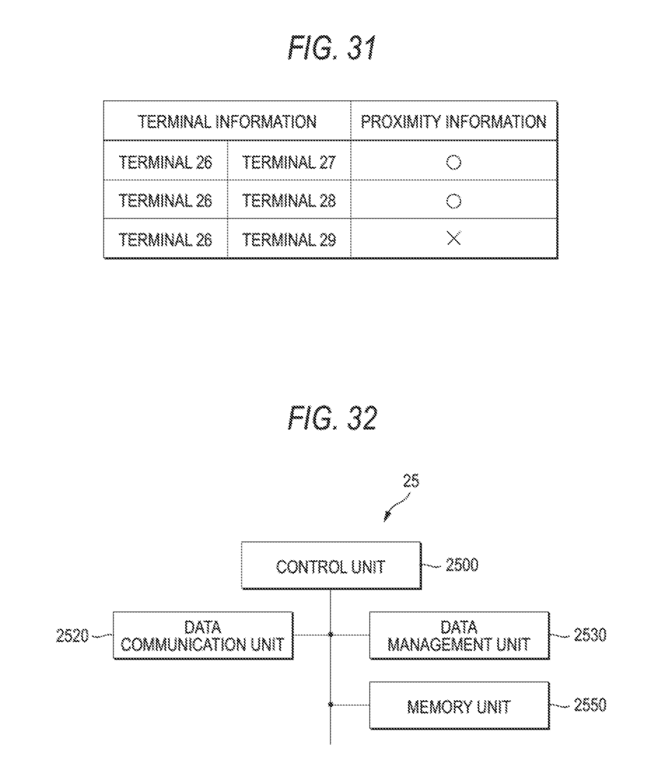

If the operation mode of the terminal 26, for example, is switched later by the user, the terminal 26 sends an operation mode switching notice to the server device 25 (step S2211). When receiving the operation mode switching notice, the server device 25 generates pieces of proximity information for respective combinations of the terminal 26 from which the operation mode switching notice has been received and the other respective terminals 27-29 on the basis of the pieces of position information stored at step S2710 (step S2712). FIG. 31 shows an example of pieces of proximity information generated at step S2712.

The server device 25 may check the operation mode switching settings of the terminals 27-29 other than the terminal 26 from which the operation mode switching notice has been received, and generate pieces of proximity information for combinations of the terminal 26 and the respective terminals 27 and 28 whose operation mode switching settings are not “invalid.” In this case, since the server device 25 does not generate proximity information for the terminal 26 and the terminal 29 whose operation mode switching setting is “invalid,” the amount of calculation can be reduced in generating pieces of proximity information.

Subsequently, the server device 25 checks the pieces of proximity information generated at step S2712, determines terminals that are close to the terminal 16 from which the operation mode switching notice has been received, and checks the operation mode switching settings of the thus-determined, respective terminals (step S2212). Then the server device 25 sends an operation mode switching instruction containing the content of the operation mode switching that was performed on the terminal 26 to each of the terminals 27 and 28 whose operation mode switching settings are not “invalid” among the terminals that are dose to the terminal 26 (steps S2213-1 and S2213-2).

Since the operation mode switching setting that is set for the self terminal is “manual,” when receiving the operation mode switching instruction from the server device 25, the terminal 27 causes the display unit to display a picture for urging the user to switch the operation mode (step S2214). FIG. 23 shows an example picture that is displayed at step S2214 when a terminal whose operation mode switching setting is “manual” receives an operation mode switching instruction.

On the other hand, since the operation mode switching setting that is set for the self terminal is “automatic,” when receiving the operation mode switching instruction from the server device 25, the terminal 28 makes a transition to the new operation mode indicated by the information contained in the operation mode switching instruction (step S2215). Then the terminal 28 causes the display unit to display a picture indicating that the operation mode has been switched (step S2216). FIG. 24 shows an example picture that is displayed at step S2216 when a terminal whose operation mode switching setting is “automatic” receives an operation mode switching instruction.

The server device 25 may send, to each terminal, an operation mode switching instruction containing information indicating the operation mode switching setting “manual” or “automatic.” In this case, it is not necessary that an operation mode switching setting be stored in each terminal. Where the operation mode switching instruction does not contain information indicating “manual” or “automatic,” each of the operation mode switching settings managed by the server device 15 may be either “valid” or “invalid.” That is, a terminal that has received an operation mode switching instruction operates according to which of “manual” and “automatic” is stored as the operation mode switching setting in the self terminal.

As in the third embodiment, until a lapse of a prescribed time from the sending of the operation mode switching instructions to the terminals 27 and 28 at step S2213-1 and S2213-2, the server device 25 disregards an operation mode switching notice even if it is received from the terminal 27 or 28.

FIG. 32 is a block diagram showing the configuration of the server device 25. As shown in FIG. 32, the server device 25 is equipped with a control unit 2500, a data communication unit 2520, a data management unit 2530, and a memory unit 2550.

The control unit 2500 is composed of a central processing unit (CPU), a timer, a memory, etc. The control unit 1500 controls the entire server device 25, that is, controls the data communication unit 2520, the data management unit 2530, the manipulation unit 2540, and the memory unit 2550.

The control unit 2500 communicates a position information acquisition request to all the registered terminals via the data communication unit 2520. The control unit 2500 receives a position information response from each registered terminal via the data communication unit 2520. The control unit 2500 stores, in the memory unit 2550, current position information of each terminal contained in each received position information response. The pieces of current information are stored by the memory unit 2550 so as to form time-series data for the respective terminals (see FIG. 28).

When receiving an operation mode switching notice via the data communication unit 2520, the control unit 1500 refers to the pieces of current position information of the respective terminals that are stored by the memory unit 2550 and generates pieces of proximity information for combinations of the terminal from which the operation mode switching notice has been received and the other respective terminals on the basis of not only the pieces of latest position information but also pieces of past position information (see FIG. 31). For a specific example, the control unit 2500 calculates, in time series, differences between pieces of position information of each pair of terminals currently stored by the memory unit 2550 and judges that two terminals are close to each other if two differences that are smaller than a threshold value occur consecutively. The pieces of proximity information generated by the control unit 2500 are stored in the data management unit 2530.

Furthermore, the control unit 1500 acquires the operation mode switching settings that are set in all the registered terminals 26-29 in advance from those terminals, respectively, via the data communication unit 2520. The acquired operation mode switching settings of the respective terminals are stored in the data management unit 2530.

The control unit 2500 refers to the pieces of proximity information and the operation mode switching settings of the respective terminals that are managed by the data management unit 2530, and selects terminals whose operation mode switching settings are not “invalid” from terminals that are close to the terminal from which the operation mode switching notice has been received. Then the control unit 2500 sends an operation mode switching instruction to each of the selected terminals via the data communication unit 520.

Until a lapse of a prescribed time from the sending of the operation mode switching instructions to the selected terminals, the control unit 2500 disregards an operation mode switching notice even if it is received from a terminal to which the operation mode switching instruction was sent.

The configuration of each of the terminals 26-29 according to the fourth embodiment is the same as the configuration of the terminal 16 which was described in the third embodiment with reference to FIG. 26.

As described above, in the fourth embodiment, the server device 25 manages pieces of position information of each of registered terminals in time series and also manages operation mode switching settings of the respective registered terminals. Furthermore, when receiving an operation mode switching notice from one of the registered terminals, the server device 25 generates pieces of proximity information for respective combinations of the terminal from which the operation mode switching notice has been received and the other terminals. Then the server device 25 sends an operation mode switching instruction to each of terminals whose operation mode switching settings are not “invalid” among terminals that are close to the terminal from which the operation mode switching notice has been received. Each terminal that has received the operation mode switching instruction performs processing relating to operation mode switching according to the operation mode switching setting that is set in the self terminal.

As described above, in the embodiment, since the server device 25 generates pieces of proximity information when receiving an operation mode switching notice, the frequency of generation of pieces of proximity information can be made lower than in the third embodiment in which pieces of proximity information are generated on a regular basis. Furthermore, since the server device 25 generates pieces of proximity information only for respective combinations of the terminal from which the operation mode switching notice has been received and the other terminals, the amount of calculation for generation of pieces of proximity information can be made smaller than in the third embodiment in which pieces of proximity information are generated for all the pairs of registered terminals. As a result, in addition to the advantages of the third embodiment, an advantage is obtained that the load that the server device 25 bears in generating pieces of proximity information can be lowered.

The present invention has been described in detail by referring to the particular embodiments, it is apparent to those skilled in the art that various changes and modifications are possible without departing from the spirit and scope of the invention.

The present application is based on Japanese Patent Application No. 2011-146165 filed on Jun. 30, 2011, the disclosure of which is incorporated herein by reference.

### INDUSTRIAL APPLICABILITY

The communication device, communication system, server device, and communication method according to the invention provide an advantage that it becomes possible to inform a user of presence of another or other communication device whose operation modes need to be switched according to operation mode switching made in a self communication device in the case where one or plural other communication device that are correlated with the communication device exist in its vicinity. The communication device is thus useful when used as a portable terminal, a smartphone, or the like.

### DESCRIPTION OF REFERENCE NUMERALS AND SIGNS

1-3, 6-8, 16-19, 26-29: Portable terminal (terminal)
4: External network
5, 15, 2: Server device
500, 1500, 2500: Control unit
520, 1520, 2520: Data communication unit
530, 1530, 2530: Data management unit
550, 1550, 2550: Memory unit
100, 1800, 2600: Control unit
110, 1810, 2610: Position detection unit
120, 1820, 2620: Data communication unit
130, 1830, 2630: Data management unit
140, 1840, 2640: Manipulation unit
150, 1850, 2650: Memory unit
160, 1860, 2660: Power unit
170, 1870, 2670: Display unit
180, 1880, 2680: RF unit

1. A communication device comprising:
a display unit;
a manipulation unit that receives an input manipulation for switching an operation mode of the communication device;
a position detection unit that detects a position of the communication device;
a communication unit that acquires position information of other communication device correlated with the communication device from the other communication device via an external network;
a generation unit that generates proximity information indicating whether the other communication device is located close to the communication device, on the basis of a detection result of the position detection unit and the position information of the other communication device;
a data storing unit that stores the pieces of proximity information; and
a control unit that, when the manipulation unit receives an input manipulation for switching the operation mode of the communication device, controls the display unit to make a display for urging a user to switch operation modes of other communication device that is close to the communication device according to a new operation mode of the communication device.

2. The communication device according to claim 1, wherein when the manipulation unit receives a prescribed manipulation after the display unit has made the display, the control unit communicates, to the other communication device, an instruction to switch to the same operation mode as the new operation mode of the communication device.

3. The communication device according to claim 2, wherein when receiving the instruction, each of the other communication device switches its operation mode to the same operation mode as the new operation mode of the communication device.

4. The communication device according to claim 1, wherein the generation unit generates, in addition to the proximity information, connection information indicating whether the other respective communication device is connected to the communication device via the external network;
wherein the data storing unit stores the connection information in addition to the proximity information; and
wherein when the manipulation unit receives an input manipulation for switching the operation mode of the communication device, the control unit controls the display unit to make a display for urging a user to switch operation modes of other communication device that is close to and is connected to the communication device according to a new operation mode of the communication device.

5. A communication system including a server device and plural communication devices that are connected to the server device via an external network, wherein the server device comprises:
an acquisition unit that acquires position information from the plural communication devices correlated with each other through the external network;
a generation unit that generates proximity information indicating whether the plural communication devices are located close to each other on the basis of the acquired position information of the plural communication devices; and
a communication unit that, when proximity information is updated, sends updated proximity information to the plural communication devices indicated by the updated proximity information; and
wherein each of the plural communication device comprises:
a display unit;
a manipulation unit that receive an input manipulation for switching an operation mode of the communication device;
a position detection unit that detects a position of the communication device;
a communication unit that acquires the proximity information from the server device through the external network; and
a control unit which controls, when the manipulation unit receives an input manipulation for switching the operation mode of the communication device, the display unit to make a display for urging a user to switch operation modes of other communication device that are close to the communication device according to a new operation mode of the communication device.

6. A communication method comprising the steps of:
receiving, by a manipulation unit, an input manipulation for switching an operation mode of a communication device;
detecting, by a detection unit, a position of the communication device;
acquiring, by an acquisition unit, position information of other communication device correlated with the communication device from the other communication device via an external network;
generating, by a generation unit, proximity information indicating whether the other communication device is located close to the communication device, on the basis of the detected position of the communication device and the position information of the other communication device;
storing the proximity information by a data storing unit; and
controlling, when receiving an input manipulation for switching the operation mode of the communication device, by a control unit, a display unit to make a display for urging a user to switch operation modes of other communication device which is close to the communication device according to a new operation mode of the communication device.

7. A communication system including a server device and plural communication device that are connected to the server device via an external network, wherein the server device comprises:
an acquisition unit that acquires position information from plural respective communication device registered in advance through the external network;
a generation unit that generates proximity information indicating whether the plural communication devices are located close to each other on the basis of the acquired position information of the plural communication devices;
a data management unit that manages the proximity information generated by the generation unit and operation mode switching settings that are set for the plural respective communication devices; and
a communication unit that receives an operation mode switching notice from one of the plural communication device through the external network, and sending, through the external network, operation mode switching instructions to a communication device that is close to the communication device from which the operation mode switching notice has been received; and
each of the plural communication devices comprises:
a display unit;
a manipulation unit that receives an input manipulation for switching an operation mode of the communication device;
a position detection unit that detects a position of the communication device;
a communication unit that sends an operation mode switching notice to the server device through the network when the operation mode of the communication device has been switched, and receives the operation mode switching instruction from the server device through the external network; and
a control unit that, when the communication unit receives the operation mode switching instruction, switches the operation mode or controls the display unit to display a picture for urging a user to switch the operation mode according to the operation mode switching setting of the communication device in response to the operation mode switching instruction.

8. A communication system including a server device and plural communication devices that are connected to the server device via an external network, wherein the server device comprises:
an acquisition unit that acquires position information from the plural communication devices registered in advance over the external network;
a memory unit that stores position information acquired by the acquisition unit in time series for each of the plural communication devices;
a generation unit that, when an operation mode switching notice is received from one of the plural communication devices through the external network, generates proximity information indicating whether the communication device from which the operation mode switching notice has been received and other communication device are located close to each other, on the basis of the position information stored by the memory unit;
a data management unit that manages the proximity information generated by the generation unit and operation mode switching settings that are set for the plural communication devices; and
a communication unit that receives an operation mode switching notice from one of the plural communication device through the external network, and sends, through the external network, operation mode switching instructions to the communication device that is close to the communication device from which the operation mode switching notice has been received; and
each of the plural communication device comprises:
a display unit;
a manipulation unit that receives an input manipulation for switching an operation mode of the communication device;
a position detection unit that detects a position of the communication device;
a communication unit that sends an operation mode switching notice to the server device through the network when the operation mode of the communication device has been switched, and receives the operation mode switching instruction from the server device through the external network; and
a control unit that, when the communication unit receives the operation mode switching instruction, switches the operation mode or controls the display unit to display a picture for urging a user to switch the operation mode according to the operation mode switching setting of the communication device in response to the operation mode switching instruction.

9. The communication system according to claim 7, wherein after sending the operation mode switching instructions to the close communication device, the server device disregards an operation mode switching setting sent from the close communication device until a lapse of a prescribed time.

10. A server device which is connected to plural communication device via an external network, comprising:
an acquisition unit that acquires position information from the plural communication devices registered in advance through the external network;
a generation unit that generates proximity information indicating whether the plural communication devices are located close to each other on the basis of the acquired position information of the plural communication devices;
a data management unit for managing the proximity information generated by the generation unit and operation mode switching settings that are set for the plural communication devices; and
a communication unit that receives an operation mode switching notice from one of the plural communication devices through the external network, and sends, through the external network, an operation mode switching instruction to the communication device that is close to the communication device from which the operation mode switching notice has been received.

11. A server device which is connected to plural communication devices through an external network, comprising:
an acquisition unit that acquires position information from the plural communication devices registered in advance through the external network;
a memory unit that stores position information acquired by the acquisition unit in time series for each of the plural communication devices;
a generation unit that, when an operation mode switching notice is received from one of the plural communication devices through the external network, generates proximity information indicating whether the communication device from which the operation mode switching notice has been received and other communication device are located close to each other, on the basis of the position information stored by the memory unit;
a data management unit that manages the proximity information generated by the generation unit and operation mode switching settings that are set for the plural communication devices; and
a communication unit that receives an operation mode switching notice from one of the plural communication devices through the external network, and sends, through the external network, an operation mode switching instruction to a communication device that is close to the communication device from which the operation mode switching notice has been received.

12. The server device according to claim 10, wherein when the communication unit has sent the operation mode switching instruction to the close communication device, the server device disregards an operation mode switching setting sent from the close communication device until a lapse of a prescribed time.

13. The communication system according to claim 8, wherein after sending the operation mode switching instructions to the close communication device, the server device disregards an operation mode switching setting sent from the close communication device until a lapse of a prescribed time.

14. The server device according to claim 11, wherein when the communication unit has sent the operation mode switching instruction to the close communication device, the server device disregards an operation mode switching setting sent from the close communication device until a lapse of a prescribed time.
